(19) United States
(12) Patent Application Publication
(10) Pub. No.: US 2025/0213052 A1
(43) Pub. Date: Jul. 3, 2025

(54) WIND UP SWING ASSEMBLY AND METHOD OF USE

(71) Applicant: WONDERLAND SWITZERLAND AG, Steinhausen (CH)

(72) Inventors: Peter R. TUCKEY, Leola, PA (US); Zachary C. HARTENSTINE, Birdsboro, PA (US); Nathanael SAINT, Morgantown, PA (US); Jonathan K. MOUNTZ, Elverson, PA (US)

(73) Assignee: WONDERLAND SWITZERLAND AG, Steinhausen (CH)

(21) Appl. No.: 18/851,644

(22) PCT Filed: Mar. 28, 2023
(86) PCT No.: PCT/US2023/016549

§ 371 Date: Sep. 26, 2024

Related U.S. Application Data
(60) Provisional application No. 63/485,756, filed on Feb. 17, 2023.
(60) Provisional application No. 63/409,439, filed on Sep. 23, 2022.
(60) Provisional application No. 63/324,825, filed on Mar. 29, 2022.

(51) Int. Cl. A47D 13/10; A47D 9/02

(52) U.S. Cl. CPC A47D 13/105; A47D 9/02

(57) ABSTRACT

The present disclosure is directed to a windup swing assembly. The windup swing assembly comprises a swing arm assembly, a drive spring, and an escapement assembly. Each of the axes of the swing arm assembly, the drive spring, and the escapement assembly can be angled relative to each other. The axis of the drive spring can be angled in a non-vertical direction relative to a vertical plane. The axis of the swing arm assembly can be angled in a non-horizontal direction relative to a horizontal plane or support surface.

### CROSS-REFERENCE TO RELATED APPLICATIONS

The present application claims the priority benefit to U.S. Provisional Patent Application No. 63/324,825, filed on Mar. 29, 2022, U.S. Provisional Patent Application No. 63/409,439, filed on Sep. 23, 2022, and to U.S. Provisional Patent Application No. 63/485,756, filed on Feb. 17, 2023, all of which are incorporated herein by reference as if fully set forth in their entirety.

### TECHNICAL FIELD

The present disclosure generally relates to a child swing assembly and is more specifically directed to a non-motorized child swing assembly.

### BACKGROUND

Child swings are well known. Many known child swings are powered either through electricity or batteries. These types of child swings can be considered motorized swings because there is a dedicated motor unit or other driving mechanism that imparts periodic or swaying motion and that requires a power source. Due to environmental concerns, there is a growing commercial demand in many consumer sectors for more eco-friendly products that do not require electrical power to operate, which often requires consumption of fossil fuels, or batteries, which can be harmful to the environment.

Prior to the commercial emergence of motorized swings, many known child swings relied on manual power or were powered by a horizontally positioned drive spring. Typically, the drive spring had a central axis (i.e., drive spring axis) that extended along a horizontal direction and was arranged overhead of the child swing.

While use of a drive spring to power a swing assembly may address the growing demand for more environmentally friendly child swing options, conventional drive-spring powered swings typically have drawbacks that can make them less desirable. For example, conventional windup swings have relatively short run times (e.g., 20 minutes) after being fully wound. Additionally, conventional windup swings typically require a large footprint or occupy a large space.

In addition to increasing the run time and reducing the footprint for a windup child swing, it can also be difficult to efficiently transfer forces between the various sub-components of the swing assembly, such as a drive spring, an escapement assembly, and a swing arm assembly.

Due to the relatively low amount of energy that can be stored in a spring, it is critical to have minimal energy losses due to friction. Therefore, a low friction design, especially as related to transferring rotation between axes, is required. This is also advantageous with respect to axes which are not parallel with each other. It is advantageous that the transfer of energy between axes of the various components is achieved with minimal friction losses while also maintaining a cost-effective and feasible design.

Accordingly, it would be desirable to provide a windup child swing that is compact and provides a relatively long run time that also efficiently transfers forces between the primary components.

### SUMMARY

The present disclosure relates to a windup child swing that addresses the typical drawbacks of conventional windup swings. Unlike conventional windup swings in which the drive spring is oriented along a horizontal axis above the swing itself, the swing assembly of this disclosure has a drive spring with a central axis (i.e. drive spring axis) that is oriented along a non-horizontal direction. In some examples, the drive spring axis can be angled a few degrees from a vertical direction. In some examples the drive spring axis can be angled anywhere from 45 degrees to 90 degrees from a ground support surface (i.e. perpendicular to the ground support surface). In other examples, the drive spring axis can extend along the vertical direction. The windup swing disclosed herein also has a longer run time, which can exceed 45 minutes-60 minutes based on a user winding the drive spring for approximately 20 seconds, or approximately 20-30 winds.

In an example, a windup swing assembly is provided that includes a swing arm assembly having a swing arm and a swing arm pivot. A swing arm axis (X1) is oriented in a non-horizontal direction relative to a ground surface. The windup swing assembly is configured to impart a swaying motion through the swing arm pivot and to the swing arm, which is attached to a seat frame. The swaying motion can provide a pendulum-like motion in a side to side direction, as opposed to a swinging motion in a forward to backward direction. The motion imparted to the seat frame can have an arc profile, and can be imparted in a non-vertical plane. One of ordinary skill in the art would understand that the seat frame itself can also be rotated such that the seat frame is moving side to side or front to back, depending on its orientation.

A drive spring can be provided that has a drive spring axis (X3). The drive spring axis (X3) can be oriented in a non-vertical direction and can be angled relative to the swing arm axis (X1).

An escapement assembly is also included that has an escapement axis (X2) that can be angled relative to the swing arm axis (X1).

The swing arm axis (X1), the escapement axis (X2), and the drive spring axis (X3) can each be angled relative to one another.

The swing arm assembly can include an adjustment assembly and a seat frame, and the adjustment assembly can be configured to adjust a recline angle of the seat frame.

A drive spring can be arranged laterally offset from the seat frame, as opposed to being arranged overhead from the seat frame.

A frame assembly and a base assembly can be provided to generally support the swing assembly relative to the ground surface. The frame assembly can include a support on a lower end that is configured to rest on the ground surface, and a handle defined on an upper end. Both of these features can provide additional stability for the swing assembly, particularly during winding or cranking.

A crank assembly can also be provided on the frame assembly. The crank assembly can be provided on an upper surface of the frame assembly. The crank assembly can include a crank handle that is configured to extend from the frame assembly, and rotation of the crank handle about a crank pivot provides rotational input to the spring assembly.

The crank handle can be configured to fold outward from the frame assembly in a use condition and can be configured to fold into a pocket defined on the frame assembly in a storage condition. Other arrangements for the crank assembly can be provided as one of ordinary skill in the art would appreciate. For example, the crank assembly could be provided on a lower portion of the frame.

A wind mechanism can be arranged between the crank assembly and the drive spring. A wind shaft can be connected to the crank assembly at a first end and extend inside of the drive spring. The wind shaft can be connected to a spool at a second end. An end of the drive spring is also connected to the spool, such that rotation of the wind shaft winds the drive spring via the spool.

The drive spring can include a first end connected to an attachment plate and a second end connected to the spool. The attachment plate can be attached to a first winding gear that is arranged around the wind shaft and is configured to matingly engage with a second winding gear. The second winding gear can be connected to the escapement assembly. The second winding gear can be configured to rotationally drive an escapement shaft.

The escapement assembly can also include an escapement gear fixed to the escapement shaft. The escapement gear can be configured to be driven via the second winding gear. The escapement assembly can further comprise a pawl, a dog, a carriage, an actuator, and a pusher. The pusher can include a first end connected to the actuator and a second end connected to the swing arm pivot.

An amplitude control assembly can be provided that includes a drop plate configured to selectively limit a stroke of the dog, and an amplitude control lever configured to selectively adjust a position of the drop plate. The drop plate can include an engagement portion configured to engage with a portion of the dog via a control edge, a recessed portion adjacent to the control edge, and an appendage configured to engage with a portion of the amplitude control lever. The amplitude control lever can include a first stop and a second stop that are spaced apart from each other and are each configured to engage with the appendage of the drop plate.

The windup swing assembly can further include a torque limiting clutch configured to prevent overwinding of the drive spring. In an embodiment, the torque limiting clutch can include a torque clutch spring assembled on the spool and configured to wind when the wind shaft is rotated in a winding direction and to slip when the drive spring is wound over a predetermined toque.

In another embodiment, the torque limiting clutch includes a first housing fixed to the frame assembly and operatively connected to the crank assembly, the first housing including clutch driver toothing, a clutch hub fixed to the crank assembly, and a clutch pawl pivotally connected to the clutch hub via a biasing element, the clutch pawl biased by the biasing element to selectively engage the clutch driver toothing. When the drive spring is wound via the crank assembly, the clutch pawl engages the clutch driver toothing up to a predetermined torque limit to transmit torque from the crank assembly to the drive spring. When torque transmitted by the crank assembly to the drive spring exceeds the predetermined torque limit, the clutch pawl disengages the clutch driver toothing to prevent further transmission of torque from the crank assembly to the drive spring.

In another embodiment, the torque limiting clutch includes an input shaft connected to the crank assembly, an output shaft connected to the drive spring, a cap fixed to the input shaft, and a spool fixed to the output shaft and clamped to the cap. The cap and spool can slip relative to one another when a predetermined force is overcome to prevent the drive spring from being overwound.

In another example, a swing assembly is provided including a frame assembly oriented in a non-vertical direction relative to a vertical plane, and a swing arm assembly connected to the frame assembly, the swing arm assembly including swing arm pivot pivotally attached to the frame assembly, a swing arm having a first end connected to the swing arm pivot and a second end connected to a seat assembly. The swing arm is rotatable about a swing arm axis (X1) that is oriented in a non-horizontal direction relative to a horizontal plane. The swing arm further includes a support hub positioned at the second end of the swing arm and configured to receive a seat assembly.

In another example, a windup swing assembly is provided including a frame assembly, a drive spring positioned within the frame assembly and oriented in a non-vertical direction relative to a vertical plane, a crank assembly provided on a frame assembly, the crank assembly being configured to input a driving torque to the drive spring, a seat frame rotatably connected to the frame assembly, the seat frame including a swing arm oriented in a non-horizontal direction relative to a horizontal plane, and a gear assembly connected to the crank assembly and the drive spring to transfer energy from the drive spring to provide a swinging motion to the seat frame.

A method of using a windup swing assembly is provided. The method including engaging a crank assembly by rotating a crank handle, wherein the crank assembly is connected to a wind mechanism, winding a drive spring connected to the wind mechanism, and selectively releasing energy from the drive spring via an escapement assembly having a carriage that is linked to a swing arm pivot via a pusher, such that the swing arm pivot moves in a first direction during a power stroke, and the swing arm pivot moves in a second direction during a non-power stroke.

A method of driving a seat frame of a windup swing assembly is provided. The method including rotating a crank assembly connected to a drive spring such that the drive spring is wound, the drive spring positioned along a drive spring axis (X3) oriented in a non-vertical direction relative to a vertical plane, transferring energy from the wound drive spring to an escapement assembly, the escapement assembly having an escapement axis (X2) that is angled relative to the drive spring axis (X3), and selectively releasing energy from the escapement assembly to a swing arm pivot. The swing arm pivot is connected to the seat frame and has a swing arm axis (X1), the swing arm axis (X1) oriented in a non-horizontal direction relative to a horizontal plane and being angled relative to the drive spring axis (X3) and the escapement axis (X2).

Additional embodiments are described below and in the claims.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1A is a perspective view of a windup child swing assembly.

FIG. 1B is another perspective view of the windup child swing assembly.

FIG. 1C is a top view of the windup child swing assembly.

FIG. 2 is a perspective view of the windup child swing assembly with an outer housing frame removed.

FIG. 3A is a perspective view of a top portion of a frame assembly with a crank assembly in a non-use or storage condition.

FIG. 3B is a perspective view of the top portion of the frame assembly with the crank assembly in a use condition.

FIG. 3C is a schematic view of a crank assembly according to a first embodiment.

FIG. 3D is a schematic view of a crank assembly according to a second embodiment.

FIG. 3E is a schematic view of a crank assembly according to a third embodiment.

FIG. 3F is a schematic view of a crank assembly according to a fourth embodiment.

FIG. 3G is a perspective view of a top portion of a frame assembly with a crank assembly in a non-use or storage condition according to one example.

FIG. 3H is a perspective view of the top portion of the frame assembly with the crank assembly in a use condition according to one example.

FIG. 3I is bottom view of a tower cap for the top portion of the frame assembly.

FIG. 4A is a perspective view of an upper portion of the windup child swing assembly.

FIG. 4B is a side view of the upper portion of the windup child swing assembly.

FIG. 4C is a perspective view of a bottom portion of a drive spring.

FIG. 4D is a perspective cross-sectional view of the bottom portion of the drive spring.

FIG. 4E is another perspective view of the bottom portion of the drive spring and portion of the frame.

FIG. 4F is another perspective view of the bottom portion of the drive spring and a portion of the frame according to another example.

FIG. 5A is another perspective view of an upper portion of the windup child swing assembly.

FIG. 5B is an exploded perspective view of an escapement assembly.

FIG. 5C is a perspective view of a carriage, a pivot housing, and a pusher in an assembled state.

FIG. 5D is a perspective view of the carriage, the pivot housing, and the pusher in a disassembled state.

FIG. 5E is a side cutaway view illustrating various axes of the windup child swing assembly

FIG. 5F is a magnified view of an interface between the pusher and the carriage.

FIG. 5G is a front view of the interface between the pusher and the carriage.

FIG. 5H is a magnified view of a portion of the carriage configured to receive the pusher.

FIG. 6A is a front view of an escapement assembly in a first state.

FIG. 6B is a front view of an escapement assembly in a second state.

FIG. 6C is a front view of an escapement assembly in a third state.

FIG. 6D is a front view of an escapement assembly in a fourth state.

FIG. 7A is a perspective view of an amplitude control assembly.

FIG. 7B is a front view of the amplitude control assembly in a first state.

FIG. 7C is a front view of the amplitude control assembly in a second state.

FIG. 7D is a front view of the amplitude control assembly in a third state.

FIGS. 8A-8C illustrate various phases for the pawl safety tooth and second set of toothing.

FIG. 9A is a perspective view of a torque limiting clutch according to an embodiment.

FIG. 9B is a side view of the torque limiting clutch.

FIG. 9C is a side cross-sectional view of the torque limiting clutch.

FIG. 10A is a perspective view of another example of the frame assembly.

FIG. 10B is a magnified view of a portion of the top area of the frame assembly of FIG. 10A.

FIG. 10C is another magnified view of the portion of the top area of the frame assembly of FIG. 10A.

FIG. 11 is a top perspective view of a gear assembly according to one example.

FIG. 12A is a side view of a torque limiting clutch assembly.

FIG. 12B is another side view of the torque limiting clutch assembly.

FIG. 12C is an exploded perspective view of the torque limiting clutch assembly.

FIG. 12D is a top view of the torque limiting clutch assembly in a first state.

FIG. 12E is a top view of the torque limiting clutch assembly in a second state.

FIG. 12F is a top view of the torque limiting clutch assembly in a third state.

FIG. 12G is an underside view of an internal portion of the torque limiting clutch assembly.

FIG. 12H is a perspective view of a torque limiting clutch according to an embodiment.

FIG. 121 is an exploded perspective view of the torque limiting clutch shown in FIG. 12H.

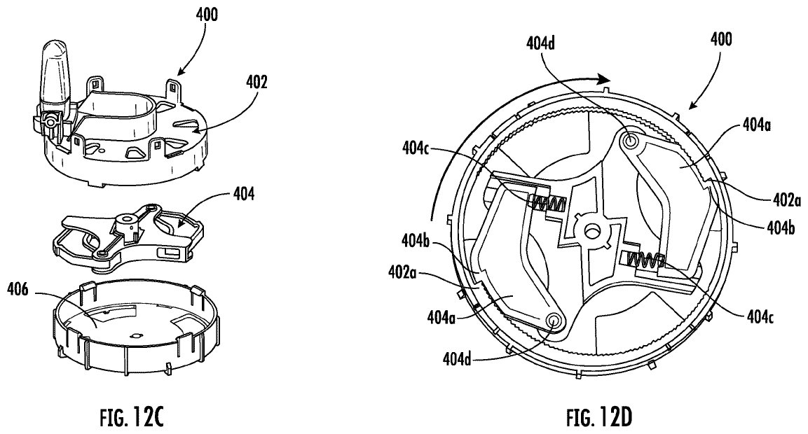

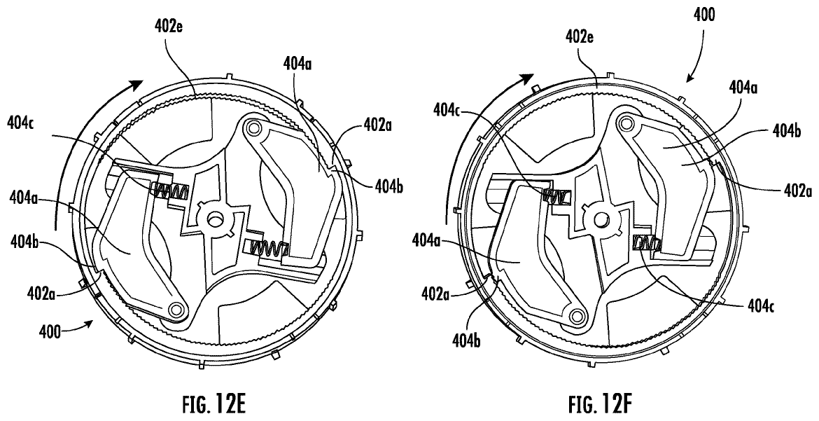

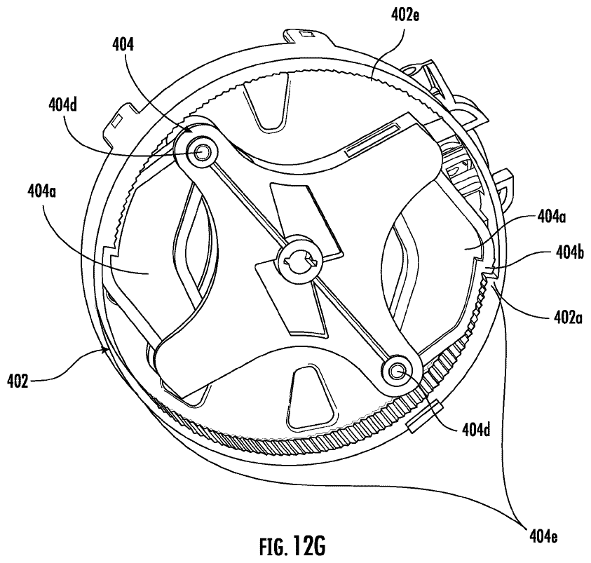

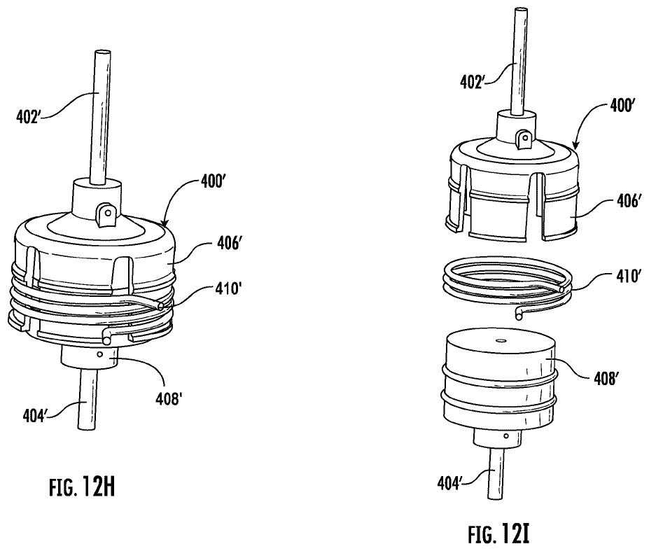

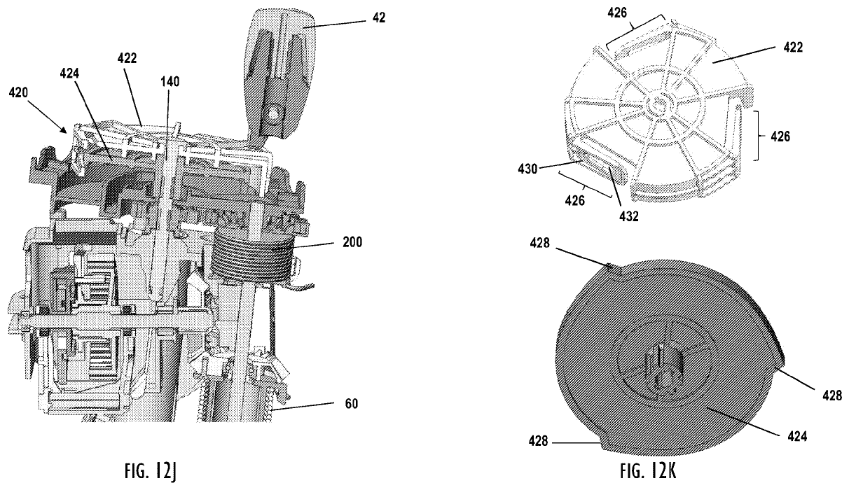

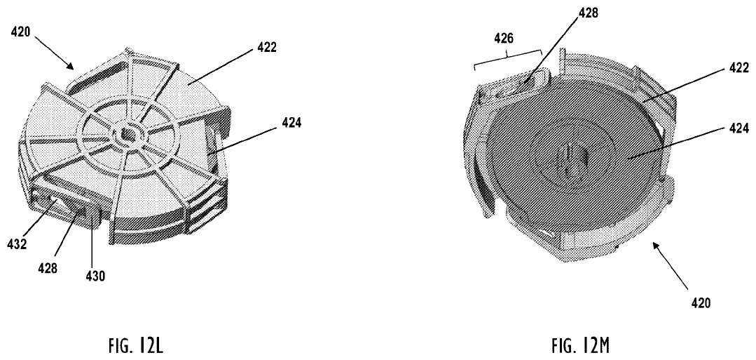

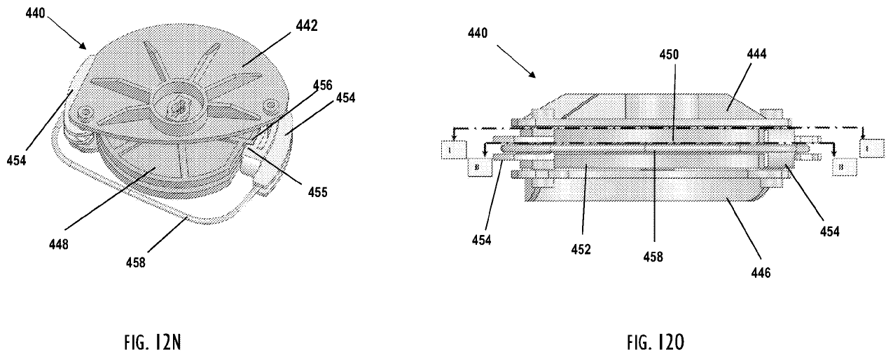

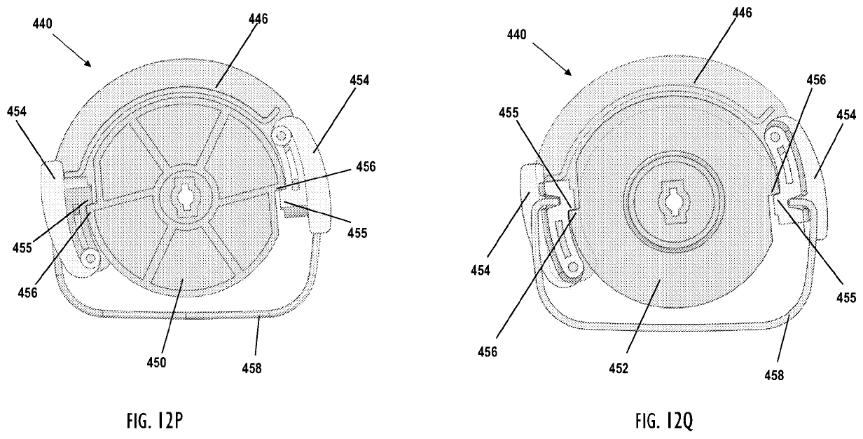

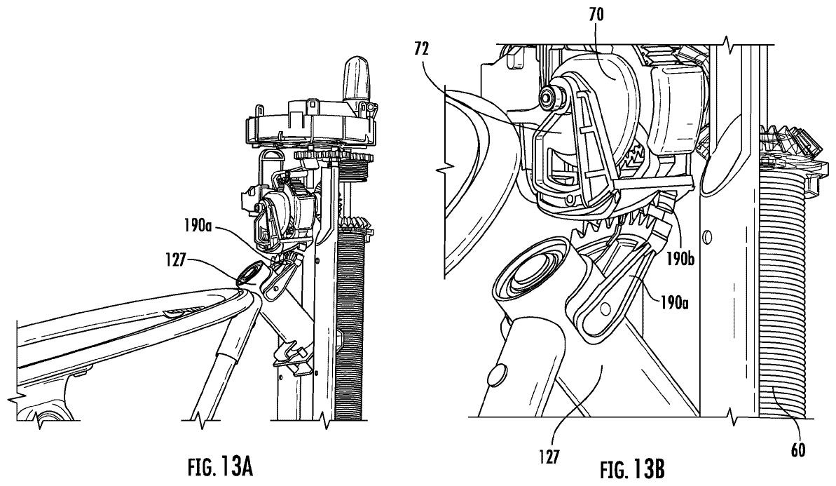

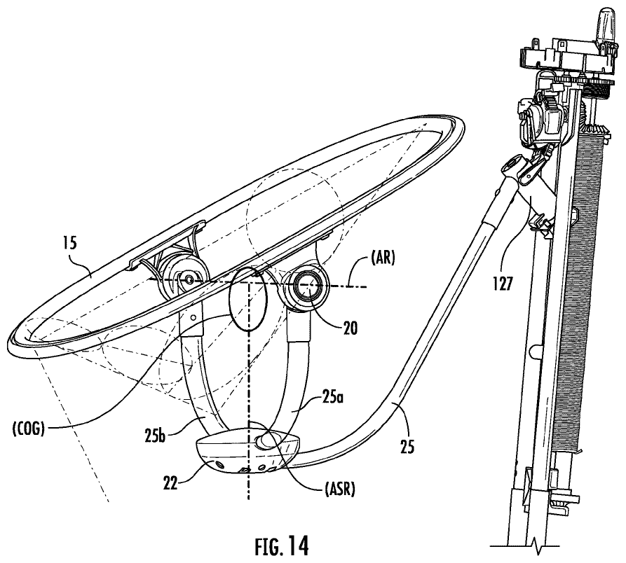

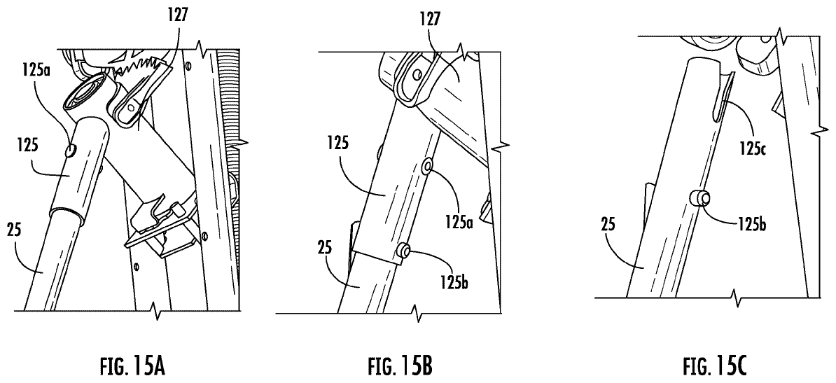

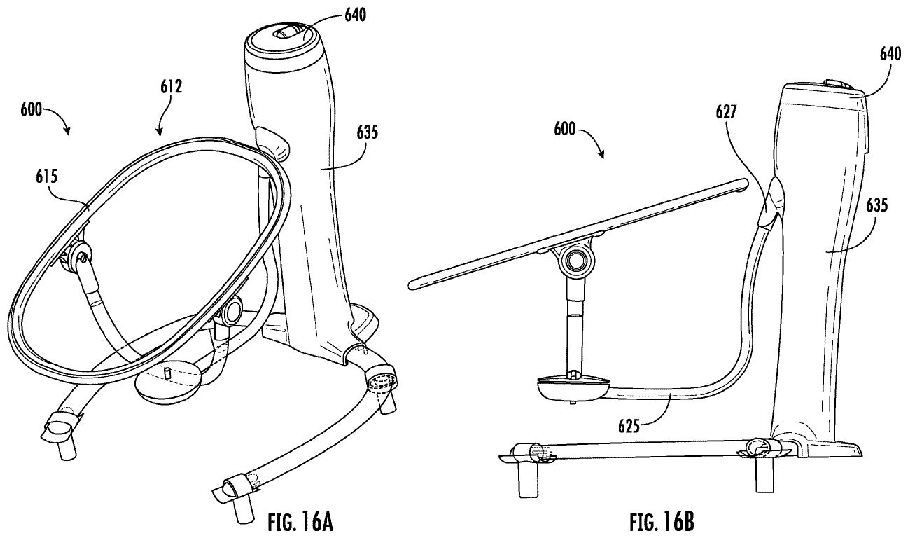

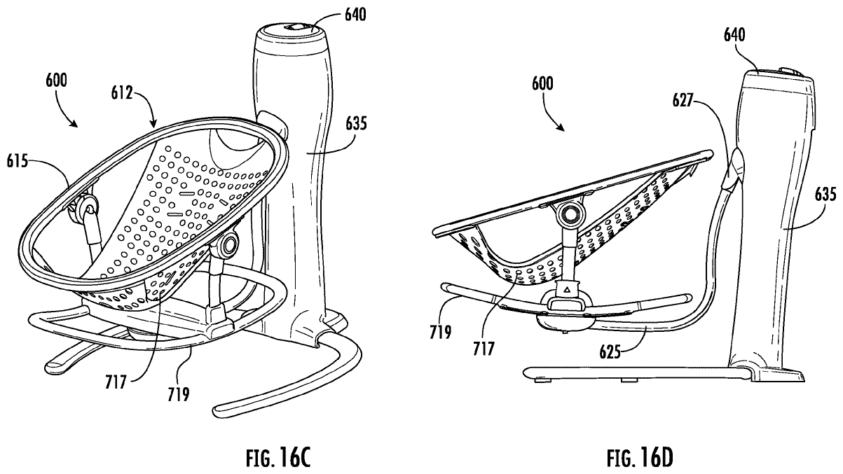

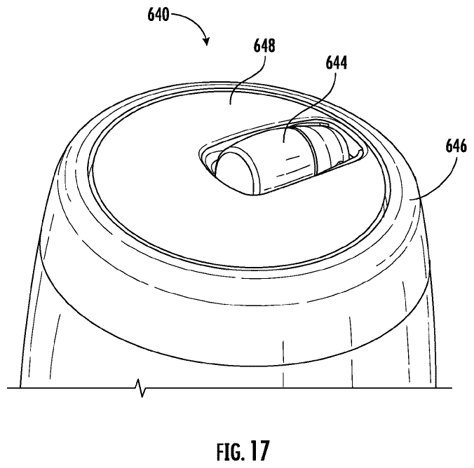

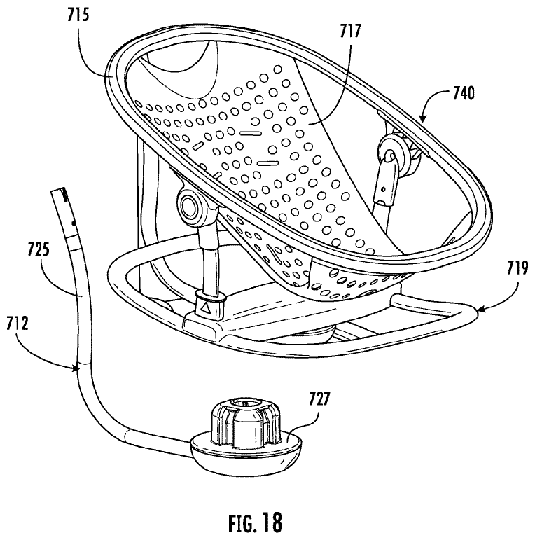

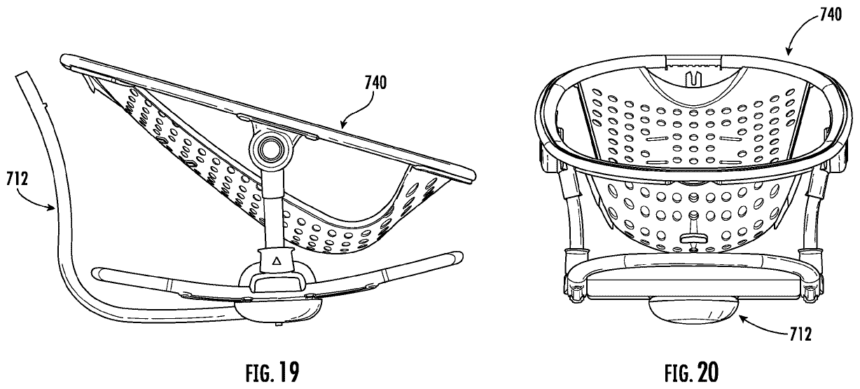

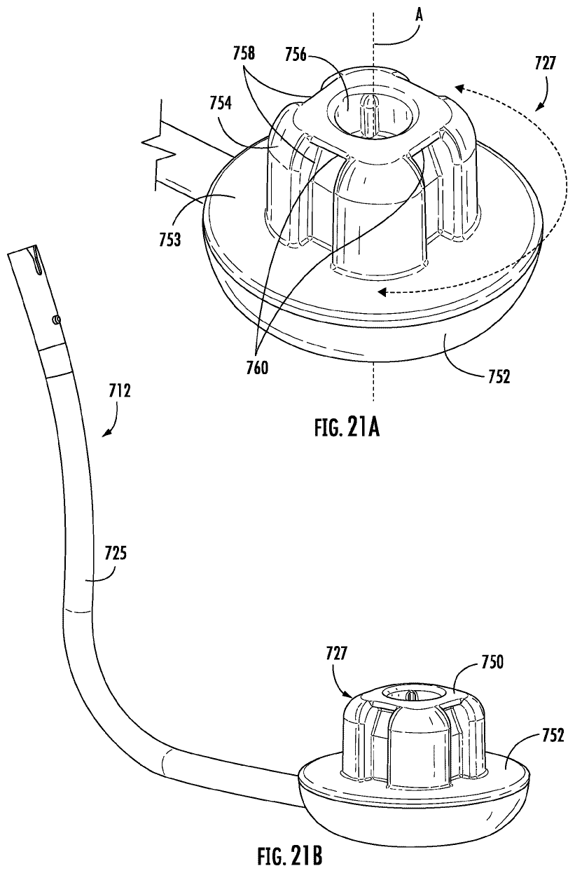

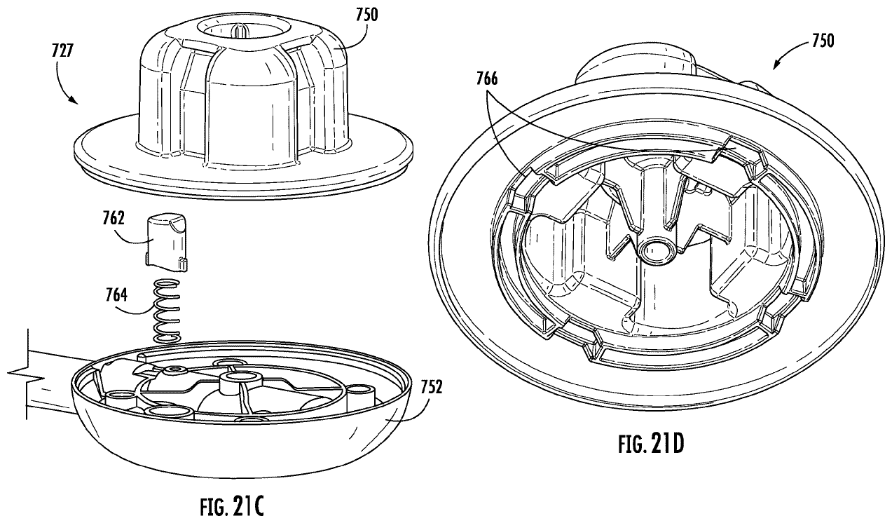

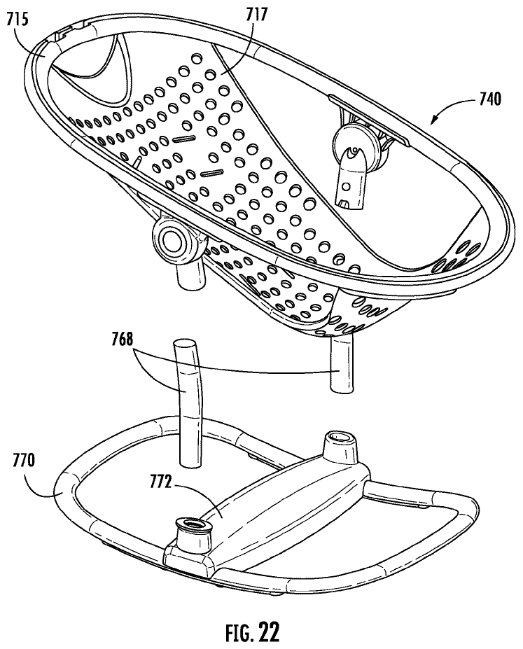

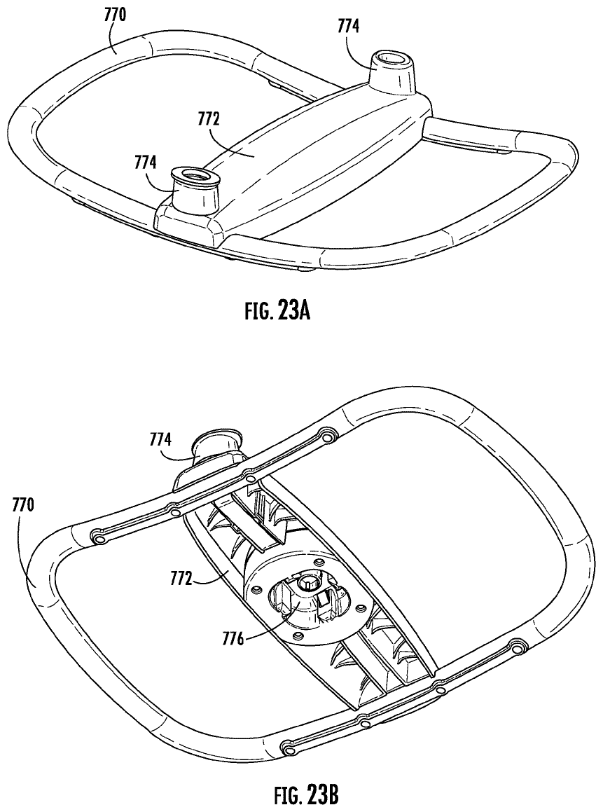

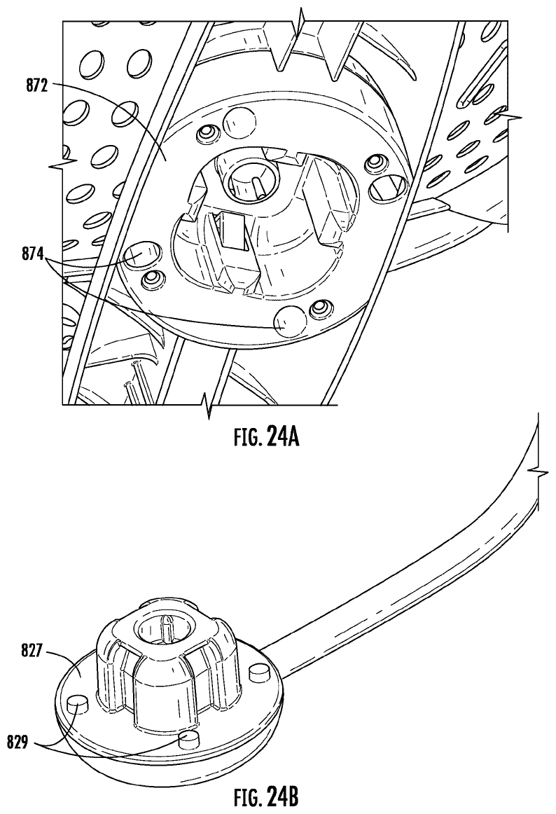

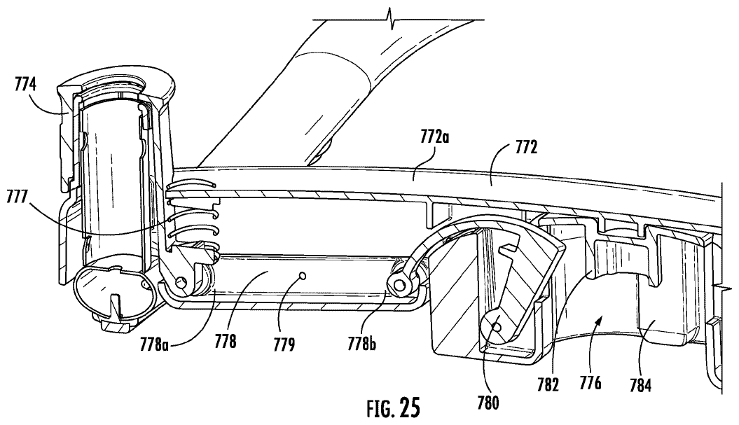

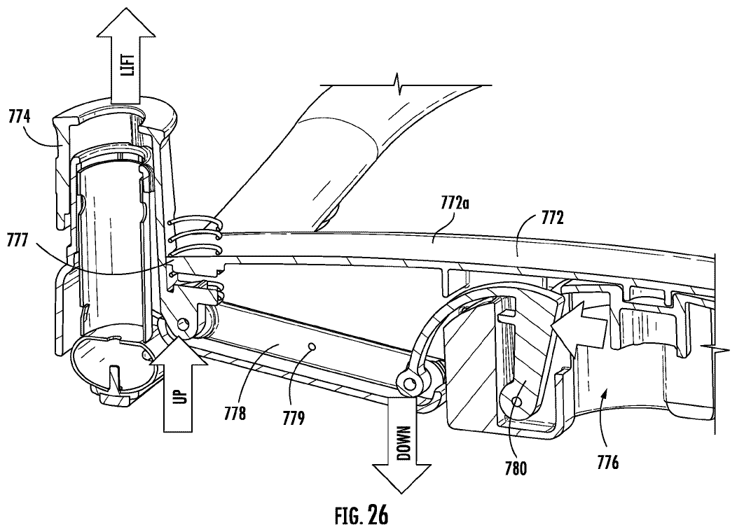

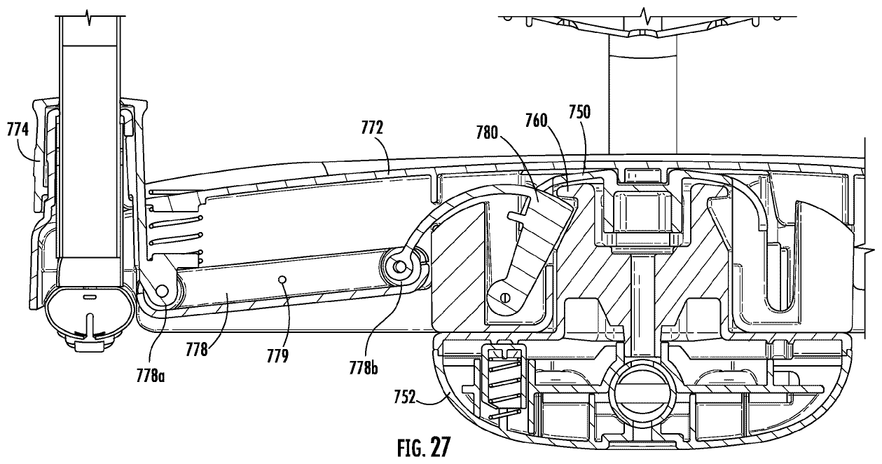

FIG. 12J is a sectional view of a torque limiting clutch according to an embodiment.

FIG. 12K is an exploded perspective view of the torque limiting clutch shown in FIG. 12J.

FIG. 12L is an perspective view of an upper side of the torque limiting clutch shown in FIG. 12J.

FIG. 12M is an perspective view of a lower side of the torque limiting clutch shown in FIG. 12J.

FIG. 12N is a perspective view of a torque limiting clutch according to an embodiment.

FIG. 120 is a plan view of the torque limiting clutch shown in FIG. 12N.

FIG. 12P is a sectional view of a torque limiting clutch taken along plane I-I shown in FIG. 120.

FIG. 12Q is a sectional view of a torque limiting clutch taken along plane II-II shown in FIG. 120.

FIG. 13A is a magnified view of an interface between the frame assembly and the swing arm.

FIG. 13B is another magnified view of the interface between the frame assembly and the swing arm.

FIG. 14 is a perspective view of the seat frame in one orientation.

FIG. 15A is a first magnified view of an interface between a swing arm and a swing arm pivot.

FIG. 15B is a second magnified view of the interface between the swing arm and the swing arm pivot.

FIG. 15C is a magnified view of the swing arm detached from the swing arm pivot.

FIG. 16A is a perspective view of a windup child swing assembly, according to an alternative aspect of this disclosure.

FIG. 16B is a side view of the windup child swing assembly shown in FIG. 16A.

FIG. 16C is a perspective view of a windup child swing assembly shown in FIG. 16A showing a seat portion and base assembly of the seat assembly.

FIG. 16D is a perspective view of a windup child swing assembly shown in FIG. 16B showing a seat portion and base assembly of the seat assembly.

FIG. 17 is a top perspective view of a crank assembly.

FIG. 18 is a perspective view of a swing arm assembly and a seat assembly positioned above the swing arm assembly.

FIG. 19 is a first side view of the swing arm assembly and the seat assembly shown in FIG. 18 with the seat assembly positioned on the swing arm assembly.

FIG. 20 is a second side view of the swing arm assembly and the seat assembly shown in FIG. 18 with the seat assembly positioned on the swing arm assembly.

FIGS. 21A and 21B are perspective views of the swing arm assembly.

FIG. 21C is an exploded perspective view of a support hub of the swing arm assembly shown in FIGS. 21A and 21B.

FIG. 21D is a bottom perspective view of a portion of the support hub shown in FIG. 21C.

FIG. 22 is a exploded perspective view of the seat assembly shown in FIG. 18.

FIGS. 23A and 23B include a top perspective view and a bottom perspective view, respectively, of a support base of the seat assembly shown in FIG. 22.

FIGS. 24A and 24B are perspective views of a connection assembly and a support hub, respectively, according to alternative aspects of this disclosure.

FIG. 25 is a cross-sectional view of a portion of the support base illustrated in FIG. 23B in a locked position.

FIG. 26 is a cross-sectional view of a portion of the support base illustrated in FIG. 23B in an unlocked position.

FIG. 27 is a cross-sectional view of a portion of the support base illustrated in FIG. 23B in a locked position with a support hub positioned within.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. A reference to a list of items that are cited as “at least one of a, b, or c” (where a, b, and c represent the items being listed) means any single one of the items a, b, or c, or combinations thereof. This terminology includes the words specifically noted above, derivatives thereof and words of similar import.

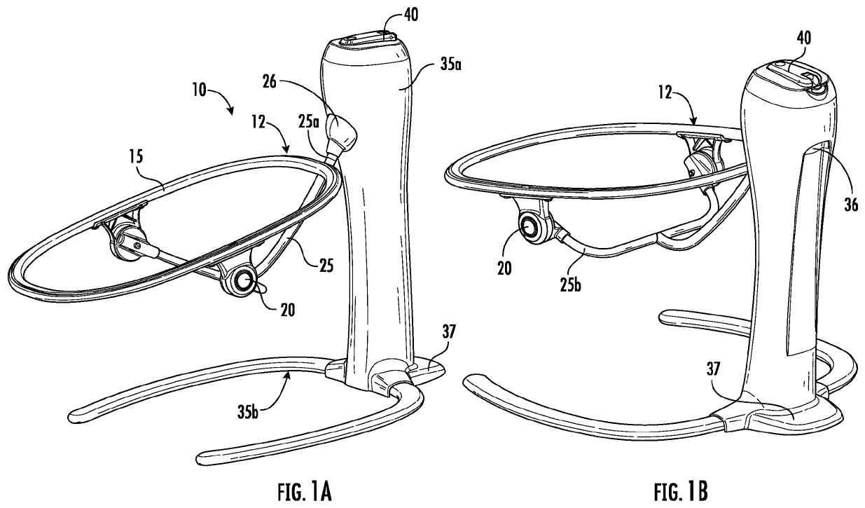

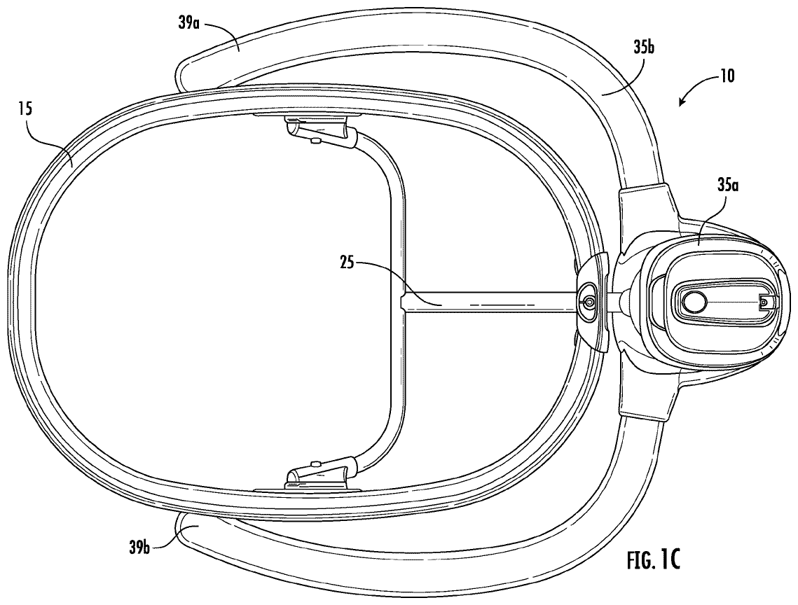

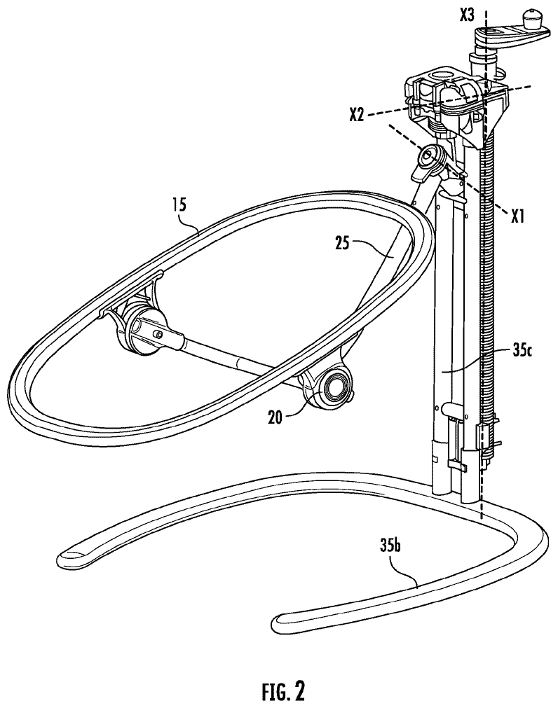

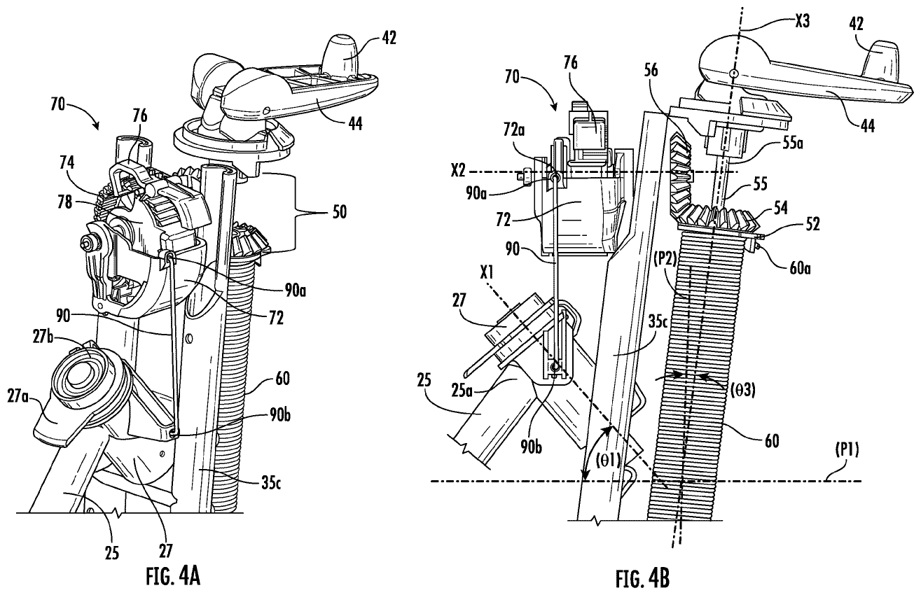

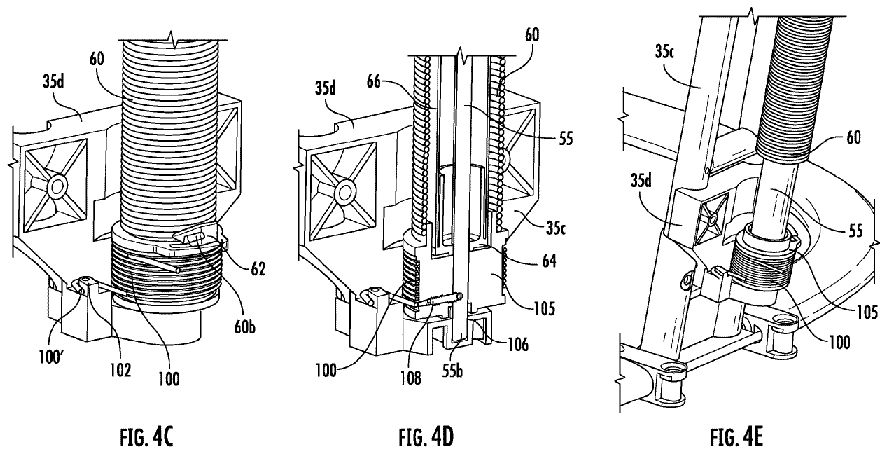

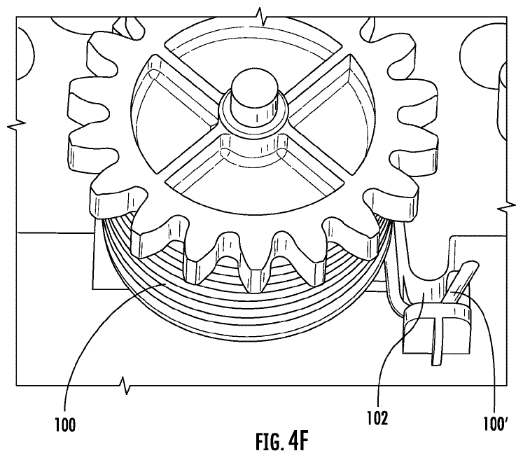

As shown in FIGS. 1A-1C, a windup swing assembly 10 is generally disclosed herein. The windup swing assembly 10 includes a swing arm assembly 12 comprising a swing arm 25 and a swing arm pivot 27 with a swing arm axis (X1), as shown in FIGS. 2, 4B, and 5E. The swing arm pivot 27 can generally include a pivot housing 27a and at least one bearing 27b, as shown in FIG. 4A. For example, and without limitation, the at least one bearing 27b can include two bearings, with a first bearing in an upper region of the pivot housing 27a and a second bearing in a lower region of the pivot housing 27a. A bottom portion of the pivot housing 27a can be supported via a portion of a frame assembly 35a, such as an upright frame member 35c, which is described in more detail herein.

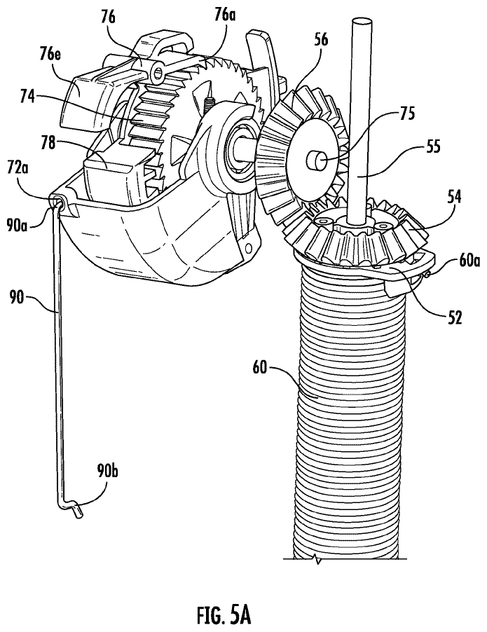

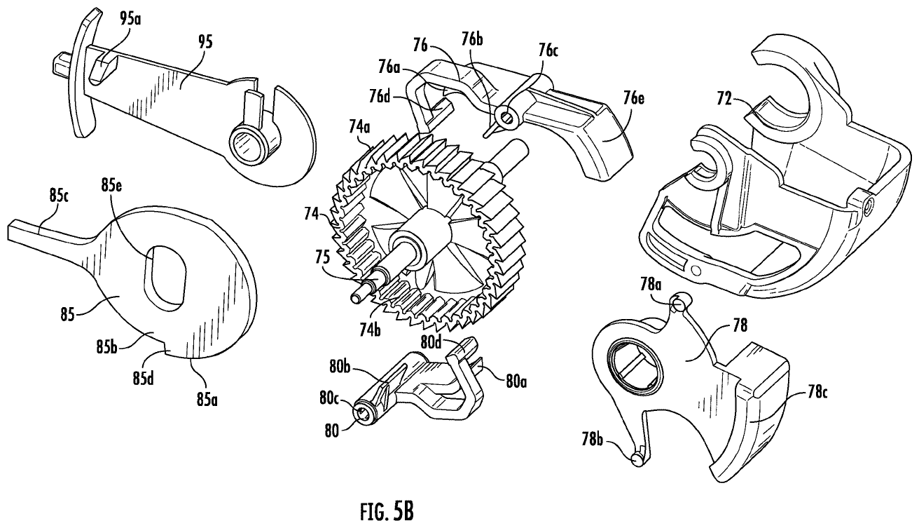

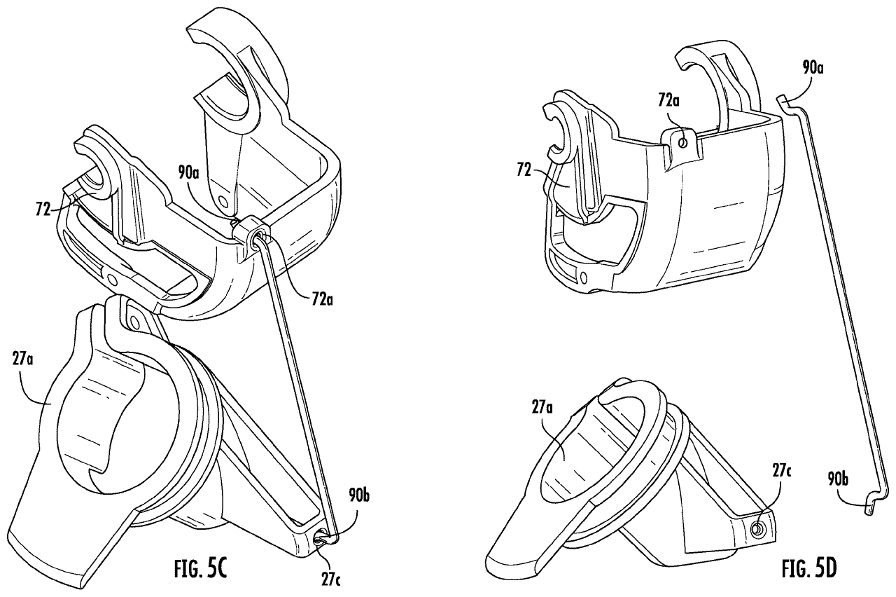

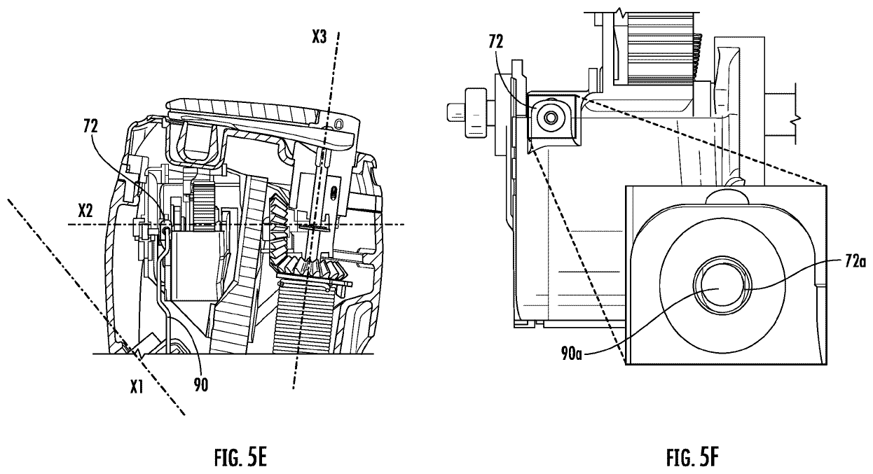

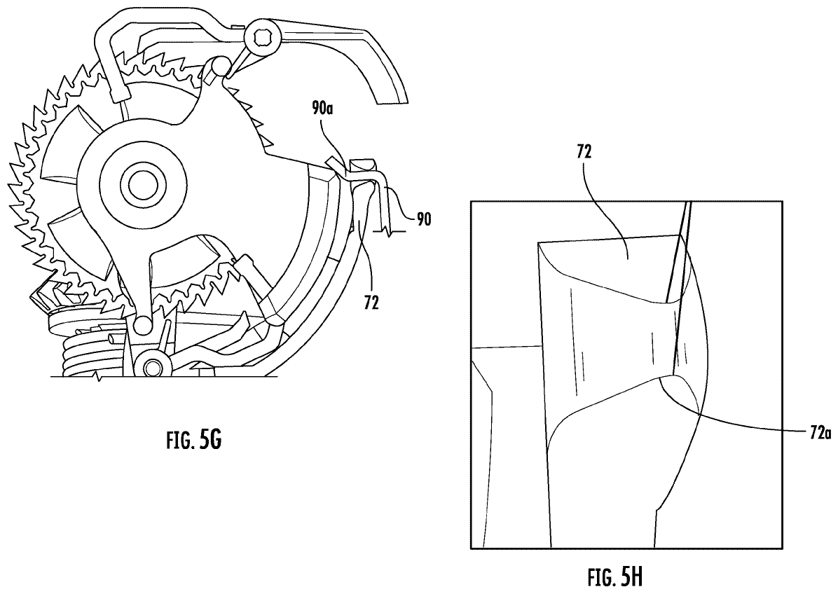

The pivot housing 27a can include an opening 27c configured to receive a portion of a pusher 90 (i.e. a first end 90a of the pusher 90), as illustrated in Figures. 5C-5D and described in more detail herein. The pivot housing 27a is configured to support the swing arm 25, and the swing arm 25 pivots about the swing arm pivot 27. The swing arm 25 can include a first end 25a configured to engage with the swing arm pivot 27 and a second end 25b configured to support a seat frame 15. A housing 26 can be provided to enclose the interface between the first end 25a of the swing arm 25 and the swing arm pivot 27.

The swing arm axis (X1) can be oriented in a non-horizontal direction or angled direction relative to a ground surface or a horizontal plane (P1) along an x-axis. In an aspect, the swing arm axis (X1) can be oriented in a non-vertical direction or angled direction relative to a vertical plane (P2). An angle (θ1) between the swing arm axis (X1) and the horizontal plane (P1) is shown in FIG. 4B. The swing arm axis (X1) can be angled relative to the ground surface or horizontal plane (P1) by 30 degrees-70 degrees. Preferably, the swing arm axis (X1) can be angled relative to the ground surface or horizontal plane (P1) by 40 degrees-60 degrees. More preferably, the swing arm axis (X1) can be angled relative to the ground surface or horizontal plane (P1) by 45 degrees-55 degrees. The swing arm axis (X1) can be angled relative to the ground surface or horizontal plane (P1) by 50 degrees in another example. The relative orientation and angle of the swing arm axis (X1) is configured to maximize the potential energy of the windup swing assembly 10 thereby increasing its running time. Additionally, the swing arm axis (X1) is arranged such that the footprint of the windup spring assembly 10 is minimized.

The windup swing assembly 10 also comprises a drive spring 60 having a drive spring axis (X3). The drive spring axis (X3) can be oriented in a non-vertical direction or angled direction relative to a vertical plane (P2) along a y-axis and can be angled relative to the swing arm axis (X1). In an aspect, the drive spring axis (X3) can be oriented in a non-horizontal direction or angled direction relative to a ground surface or the horizontal plane (P1) along an x-axis. One of skill in the art will recognize that the vertical plane (P2) is perpendicular to the horizontal plane (P1). An angle (03) between the drive spring axis (X3) and a vertical plane (P2) is shown in FIG. 4B. The drive spring axis (X3) can be angled relative to the vertical plane (P2) by 5 degrees-20 degrees. One of ordinary skill in the art would understand that the drive spring axis (X3) can be angled relative to the vertical plane (P2) by more than 20 degrees in another configuration depending on the arrangement of any associated bevel gears. Preferably, the drive spring axis (X3) can be angled relative to the vertical plane (P2) by 5 degrees-15 degrees. More preferably, the drive spring axis (X3) can be angled relative to the vertical plane (P2) by 5 degrees-10 degrees. The drive spring axis (X3) can be angled relative to the vertical plane (P2) by 7 degrees in one example. The orientation and angle of the drive spring axis (X3) can be selected to optimize the stability of the windup swing assembly 10, while also ensuring that the center of gravity for the windup swing assembly 10 is positioned relative to a base assembly 35b to minimize the risk of any inadvertent tipping.

The windup swing assembly 10 also comprises an escapement assembly 70 having an escapement axis (X2). The escapement axis (X2) can be angled relative to the swing arm axis (X1). The escapement axis (X2) can be substantially parallel to the ground surface or horizontal plane (P1). Alternatively, one of ordinary skill in the art would understand that the escapement axis (X2) can be angled relative to the ground surface or horizontal plane (P1).

The swing arm axis (X1), the escapement axis (X2), and the drive spring axis (X3) can each be angled relative to one another, which is shown in FIGS. 2, 4B, and 5E. As shown in FIG. 4B, the swing arm axis (X1), the escapement axis (X2), and the drive spring axis (X3) can be angled relative to each other. The relative angle between any of the first, second, and/or third axes (X1, X2, X3) can be 0 degrees to 90 degrees, in an embodiment. One of ordinary skill in the art would understand that these angles can vary depending on the particular configuration desired for the windup spring assembly 10. Additionally, the first, second, and/or third axes (X1, X2, X3) can be arranged at any relative angle, and can be arranged in multiple different planes in another embodiment.

Referring back to FIGS. 1A and 1B, the swing arm assembly 12 can include an adjustment assembly 20 and the seat frame 15, in addition to the swing arm 25. The adjustment assembly 20 can be configured to adjust a recline angle of the seat frame 15, and the adjustment assembly 20 can be released or engaged via a button, lever, or other actuation/adjustment feature. The seat frame 15 can be configured to be adjustable from 0 degrees relative to a horizontal plane (i.e. flat) to an incline of at least 20 degrees-30 degrees relative to a horizontal plane (in either a positive or negative direction). i

As opposed to an overhead windup spring assembly, which requires vertical space for supporting the drive spring, the windup swing assembly 10 disclosed herein positions the drive spring 60 laterally adjacent or to the side of the seat frame 15. The drive spring 60 is therefore not positioned overhead relative to the seat frame 15.

The windup swing assembly 10 also comprises a frame assembly 35a, a base assembly 35b, and an upright frame member 35c. The frame assembly 35a, including the upright frame member 35c and base assembly 35b, can include an outer shell or housing that generally encloses or encases internal components, such as the drive spring 60.

The frame assembly 35a can include a support 37 on a lower end and a handle 36 on an upper end. The support 37 is configured to provide an additional stabilizing surface that engages with a ground surface. The support 37 can be formed as a protrusion that is sufficiently large enough to accommodate a user's foot on an upper side such that a user can step on the support 37 and stabilize the windup swing assembly 10 while winding the drive spring 60 via a crank assembly 40. The support 37 can extend outward from a remainder of the frame assembly 35a. For example, and without limitation, the support 37 can extend outward from the frame assembly 35a by at least three inches. In an example, and without limitation, the support 37 can have a height of less than one inch. The support 37 preferably extends from the frame assembly 35a in an opposite direction from the base assembly 35b.

The handle 36 can be provided as a lip, edge, or other type of recess formed on the frame assembly 35a. One of ordinary skill in the art would understand that the handle 36 could be formed on other areas of the windup swing assembly 10 besides the frame assembly 35a. The handle 36 can be dimensioned or configured to accommodate a user's hand to provide additional support for the windup swing assembly 10 while winding the drive spring 60. The handle 36 can also be used to lift or otherwise move the windup swing assembly 10. For example, and without limitation, the handle 36 can have a depth of at least one inch, and preferably a depth of at least two inches. The handle 36 is configured to allow a user to more easily move the windup swing assembly 10 and improves the overall mobility of the windup swing assembly 10.

The base assembly 35b can be formed as two legs 39a, 39b that extend from the upright frame member 35c, which is shown in a top view in FIG. 1C. In one example, the base assembly 35b can include two curved or arcuate legs 39a, 39b that generally have a U-shaped profile or horseshoe profile. As shown in FIG. 1C, the base assembly 35b can generally have a profile that at least partially overlaps or falls within the profile or outline of the seat frame 15 (as shown by the ends of the legs 39a, 39b). One of ordinary skill in the art would understand that the profile of the base assembly 35b can vary.

The windup swing assembly 10 also includes a crank assembly 40 that provides an interface for a user to impart movement or energy on the drive spring 60. The crank assembly 40 can be generally arranged on the frame assembly 35a. The crank assembly 40 can be provided on an upper surface of the frame assembly 35a. One of ordinary skill in the art would understand that the crank assembly 40 can be arranged on other portions or regions of the frame assembly 35a, or any other portion of the windup swing assembly 10.

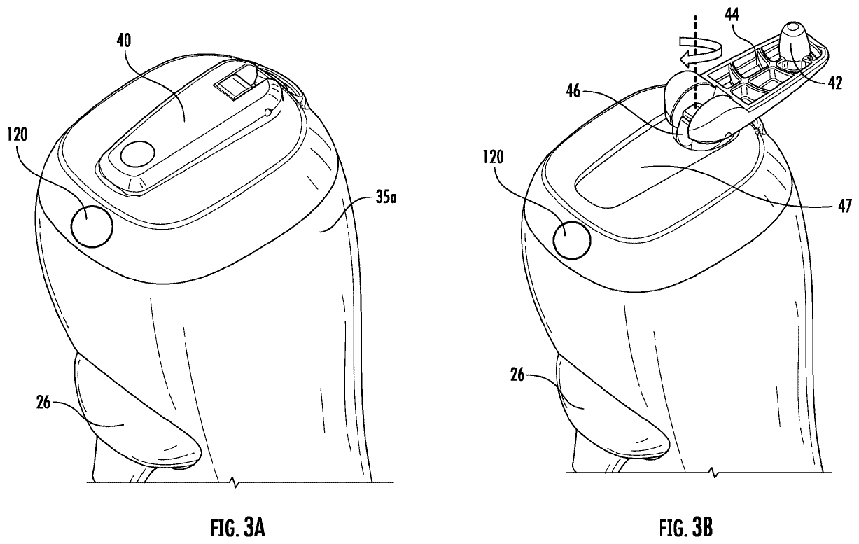

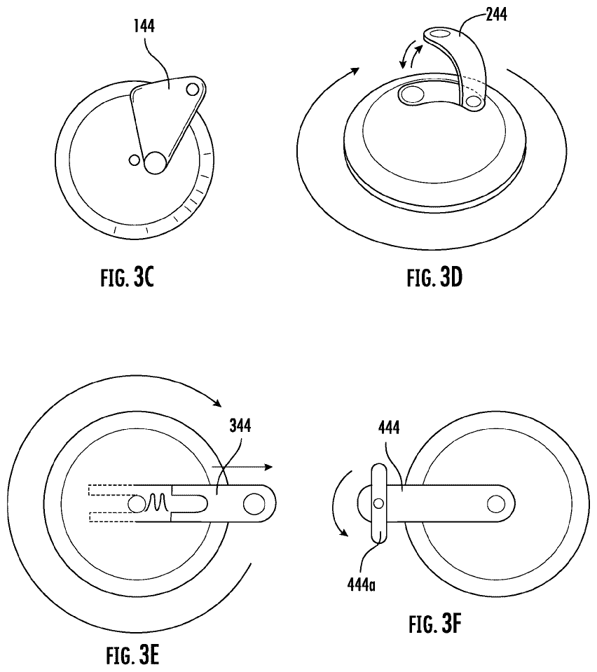

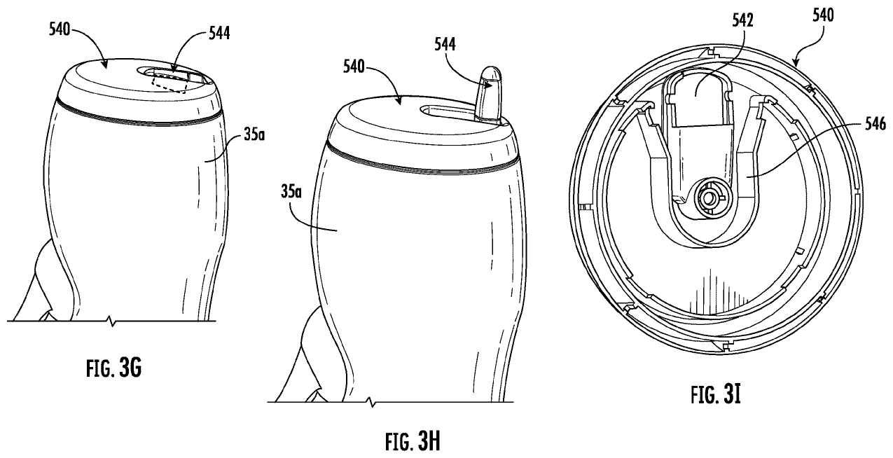

As shown in FIGS. 3A and 3B, the crank assembly 40 can include a crank handle 44 that is configured to extend from the frame assembly 35a. Rotation of the crank handle 44 about a crank pivot 46 provides input to the drive spring 60. The crank handle 44 can be configured to fold outward from the frame assembly 35a in a use condition and can be configured to fold into a pocket 47 defined on the frame assembly 35a in a storage condition. A grip 42 can be provided on the crank handle 44 that is configured to be engaged by the user while winding the drive spring 60.

An energy level indicator can be provided for the windup swing assembly 10. The energy level indicator 120 is shown in one example in FIGS. 3A and 3B. The energy level indicator 120 can be a torque sensor, in one example, and can be operatively arranged between the drive spring 60 and the crank assembly 40. The energy level indicator 120 can provide indicia, such as a gauge, which shows the amount of energy stored by the drive spring 60. A user can quickly determine how much time is left for the swinging motion to continue, and decide to further engage the crank assembly 40. The energy level indicator 120 can include a sensor or spring that is arranged in series with the drive spring 60. One of ordinary skill in the art would understand that various configurations are possible to measuring the energy in the drive spring 60. Additionally, the location and specific form of the energy level indicator 120 can vary.

As shown in FIGS. 3C-3F, various configurations for the crank assembly 40 can be provided. As shown in FIG. 3C, an arm 144 of the crank assembly 40 can operate as a handle that rotates outwards in the use or cranking position, and can be provided off center from a middle portion of the frame. As shown in FIG. 3D, an arm 244 of the crank assembly 40 can operate as a handle that also rotates outwards from the frame. Increasing the arm length can provide greater input to the drive spring 60. As shown in FIG. 3E, an arm 344 of the crank assembly 40 can translate radially outwards to operate as a handle. As shown in FIG. 3F, an arm 444 of the crank assembly 40 can have a rotating portion 444a that is configured to be gripped by the user.

FIGS. 3G-31 provide additional views of the crank assembly according to another example. In one configuration, a tower cap 540 is provided that generally attaches to a top portion of the frame assembly. The tower cap 540 can include an opening 542 configured to allow an arm 544 of the crank assembly 40 to extend therethrough. The arm 544, which can also be referred to as a knob, can be configured to be rotated to wind the drive spring 60. The arm 544 can be configured to be biased with a spring or biasing element to the closed or non-use position, which can serve as a safety function. The tower cap 540 can be snap fitted to a body of the frame assembly 35a. The tower cap 540 can include an inner wall 546 that corresponds to a wall of a first housing 402 of a torque limiting clutch assembly 400 (which is shown in more detail in FIGS. 12A-12G and described in more detail herein), which creates a tight fit between the tower cap 540 and the first housing 402 with minimal rotational movement (e.g. wiggle) between the two. The inner wall 546 also helps with aligning the tower cap 540 with the clutch assembly 400 during assembly. The winding knob or arm 544 can be configured to pivot down to be flush with the tower cap 540 for safety purposes and also a cleaner aesthetic appearance.

As shown in detail in FIGS. 4A and 4B, the windup swing assembly 10 further comprises a wind mechanism 50 that is arranged between the crank assembly 40 and the drive spring 60. The wind mechanism 50 is generally configured to provide an interface between the crank assembly 40 and the drive spring 60, such that cranking input from the user is translated to winding of the drive spring 60. The wind mechanism 50 can include a wind shaft 55 connected to the crank assembly 40 at a first end 55a of the wind shaft 55, as shown in FIG. 4B. The wind shaft 55 can extend inside of the drive spring 60 and can be connected to a quiet wind spool 105 at a second end 55b of the wind shaft 55 as illustrated in FIG. 4D-4E. Alternative arrangements for the wind shaft 55 can be provided.

Referring to the wind mechanism 50 as shown in FIGS. 4A and 4B, an attachment plate 52 can be attached to a first winding gear 54 that is arranged around the wind shaft 55 and is configured to matingly engage with a second winding gear 56. The first and second winding gears 54, 56 can be bevel gears, in one example. The second winding gear 56 can be connected to the escapement assembly 70. In one configuration, the second winding gear 56 is configured to rotationally drive an escapement shaft 75 (illustrated in FIGS. 5A-5B). Alternative arrangements can be provided for translation of the motion or energy from the drive spring 60 to the escapement assembly 70.

As shown in FIG. 4A-4E, the drive spring 60 can include a first end 60a connected to the attachment plate 52 and a second end 60b connected to the quiet wind spool 105, such that rotation of the wind shaft 55 winds the drive spring 60 via the quiet wind spool 105.

As shown in FIGS. 4C-4E, a power tube 66 is provided that centers the drive spring 60 and prevents the drive spring 60 from snaking or otherwise tangling during winding. A first bearing 64 can be provided that supports both the wind shaft 55 and the power tube 66. A second bearing 106 can be provided between a portion of the upright frame member 35c and the wind shaft 55.

The quiet wind spool 105 can define a connection 62 with the second end 60b of the drive spring 60. Turning the wind shaft 55 clockwise causes rotation of the quiet wind spool 105, which winds the drive spring 60 via the connection 62. A connector 108 can be provided that connects the wind shaft 55 to the quiet wind spool 105. The connector 108 can include a set screw, knurled connection, or any other attachment configuration that connects the wind shaft 55 with the quiet wind spool 105.

A slip clutch spring 100 can also be provided that is generally configured to prevent rotation of the wind shaft 55 in a non-winding direction. Turning the wind shaft 55 in the winding direction, such as the clockwise direction as shown in the Figures, causes the slip clutch spring 100 to open and slip. In contrast, turning the wind shaft 55 in the non-winding direction causes the slip clutch spring 100 to tighten around the quiet wind spool 105. When a user stops winding the wind shaft 55, the counterclockwise force on the quiet wind spool 105 causes the slip clutch spring 100 to tighten. This slip clutch spring 100 resists the release of energy from the drive spring 60 whenever the drive spring 60 is in a wound position, both during winding and when the swing is running. Therefore, in the event of a mechanical failure in the escapement mechanism, the winding crank (i.e. knob, spring, etc.) will not spin uncontrollably releasing energy, which provides a safety feature and prevents injury to users. As shown in FIGS. 4C-4E, a bracket 35d can be provided that is secured to the upright frame member 35c. The rotational torque of the drive spring 60 is thereby resisted by the attachment of the slip clutch spring 100 to a pin 102 that is connected to the bracket 35d or upright frame member 35c. FIG. 4E illustrates the drive spring 60 pulled upward from the bottom portion of the frame for illustrative purposes only. As shown in FIG. 4F, an end 100′ of the slip clutch spring 100 can secured to a portion of the bracket 35d or upright frame member 35c.

The escapement assembly 70 is configured to control the release of energy from the drive spring 60 and is configured to provide discrete and controlled bursts of energy to drive the seat frame 15. The escapement assembly 70 is also configured to prevent the drive spring 60 from inadvertently unwinding. The escapement assembly 70 can comprise an escapement gear 74 comprising a plurality of teeth 74a and configured to be driven via the connection of the escapement shaft 75 to the second winding gear 56. The escapement gear 74 can be fixed to the escapement shaft 75. One such escapement assembly is disclosed in U.S. Pat. No. 6,283,870, which is incorporated by reference as if fully set forth herein.

The escapement assembly 70 is shown in further detail in FIGS. 5A-5B, along with a drop plate 85 and amplitude control lever 95. The escapement assembly 70 can further include a carriage 72, a pawl 76, an actuator 78, a dog 80, and a pusher 90, each of which is described in more detail herein.

The pawl 76 is pivotably supported at a pawl pivot 76c. In an aspect, the pawl pivot 76c can be pivotably attached to a portion of the frame assembly 35a, for example, such as the upright frame member 35c. The force of the drive spring 60 biases the escapement gear 74 to rotate in the drive direction, such as the clockwise direction. However, in an initial state, a pawl tooth 76a is engaged with a tooth 74a the escapement gear 74 to prevent the escapement gear 74 from rotating clockwise, and also to prevent the drive spring 60 from unwinding all at one time. The biasing of the escapement gear 74 clockwise due to the drive spring 60 force causes the escapement gear 74 to apply a force to the pawl 76 that keeps the pawl tooth 76a engaged with the escapement gear 74. Without this engagement, a pawl weight 76e would cause the pawl 76 to rotate clockwise due to gravity and therefore rotate out of engagement with the escapement gear 74.

The carriage 72 is coupled to the escapement shaft 75 and configured to rotate about the escapement axis (X2). The carriage 72 is also coupled to a first end 90a of the pusher 90. A second end 90b of the pusher 90 is coupled to the swing arm assembly 12. When the escapement gear 74 is driven via the connection of the escapement shaft 75 to the second winding gear 56, the carriage 72 pushes the swing arm assembly 12 to rotate during a power stroke and is pushed by the swing arm assembly 12 during a non-power stroke. The swing arm assembly 12 is configured to swing in a pendulum-like motion. During the power stroke, energy from the drive spring 60 is transferred through the escapement assembly 70 to drive the swing arm assembly 12 in a first direction. After reaching the end of that stroke or sway, inertia then drives the swing arm assembly 12 in a second direction, opposite from the first direction. This process continues for as long as there is stored energy remaining from the winding of the drive spring 60.

The dog 80 is pivotably fixed to the carriage 72 at the dog pivot 80c such that the dog 80 moves with the carriage 72 as the carriage 72 rotates about the escapement axis (X2) with the swing arm assembly 12. The shape of the dog 80 and the configuration of dog teeth 80a, 80d is such that the dog weight causes the dog 80 to rotate clockwise about the dog pivot 80c so that the dog tooth 80a is disengaged from a tooth 74a of the escapement gear 74.

The actuator 78 is coupled to the escapement shaft and configured to rotate about the escapement axis (X2). The actuator 78 is configured to selectively engage the dog 80 via a dog engagement surface 78b that engages a dog control arm 80b. The actuator 78 is also configured to selectively engage the pawl 76 via a pawl engagement surface 78a that engages a pawl control arm 76b. This selective engagement controls the movement of the dog 80 and the pawl 76. The actuator 78 also includes an actuator weight 78c that is positioned such that the actuator 78 is biased in the clockwise direction when not being acted upon by either the pawl 76 or the dog 80.

The pusher 90 operatively connects the escapement assembly 70 to the swing arm assembly 12. The pusher 90 is generally configured to convert rotation from the escapement assembly 70 about the escapement axis (X2) to sway or swinging of the swing arm 25 about the swing arm axis (X1). The pusher 90 can be a rigid wire, in one example. One of ordinary skill in the art would understand that the pusher 90 could include a pair of bevel gears, or any type of mechanical linkage. For example, in the embodiment shown in FIGS. 13A and 13B, a swing arm pivot 127 can include a first bevel gear 190a. A second bevel gear 190b can be configured to drivingly engage with the first bevel gear 190a. The second bevel gear 190b can be connected to the carriage 72, or another portion of the frame assembly. In one configuration, the second bevel gear 190b can be formed integrally with the carriage 72. The driving connection between the bevel gears 190a, 190b imparts the swaying or swinging motion to the swing arm 25, and otherwise provides the same function as the pusher 90 and its associated components. The configuration including the bevel gears can be configured to provide a 1:1 ratio of rotational motion between the first and second bevel gears 190a, 190b, thereby providing a more efficient swinging configuration.

The pusher 90 includes a first end 90a connected to the carriage 72 and a second end 90b connected to the swing arm pivot 27. The pusher 90 can be configured to be rotated and displaced with multiple degrees of freedom. The first and second ends 90a, 90b of the pusher 90 can be retained within the carriage 72 and the swing arm pivot 27 with a predetermined amount of slack or predetermined tolerance such that some predetermined amount of play is possible as the pusher 90 is driven back and forth for the swinging motion.

As shown in FIGS. 5C and 5D, the first and second ends 90a, 90b of the pusher 90 can include bent or angled portions relative to a main body of the pusher 90. For example, the first end 90a can be bent upward and the second end 90b can be bent downward. The first end 90a is configured to be retained in an opening 72a of the carriage 72. The opening 72a in the carriage 72 can include a through hole with at least one tapered region adjacent to the through hole. The opening 27c in the pivot housing 27a can also include a through hole and at least one tapered region adjacent to the through hole. By not rigidly securing the ends 90a, 90b relative to the carriage 72 and the pivot housing 27a, the pusher 90 is allowed to swing more freely, which provides increasing swinging time.

FIGS. 5E-5H illustrate further aspects of the pusher 90 configuration. Referring to FIG. 5E, energy needs to be transferred from the escapement axis (X2) to the swing arm pivot axis (X1). These axes can be arranged to be non-parallel with each other, and in one configuration can be angled 40 degrees to 60 degrees relative to each other. The pusher 90 is arranged between the carriage 72 and the pivot housing 27a in order provide improved buckling strength to transmit torque. The connection of the pusher 90 to both the carriage 72 on the escapement axis (X2), and the pivot housing 27a on the swing arm pivot axis (X1) is configured to allow the pusher 90 to self-align with the respective connection hole 72a on the carriage 72 and the connection hole 27c on the pivot housing 27a. One of ordinary skill in the art would understand that the connection of the pusher 90 to pivot housing 27a is similar. The ends 90a, 90b of the pusher 90 can have a rounded or cylindrical profile. An arc contact surface provided within the connection hole 27c of the pivot housing 27a, as shown in FIG. 5C and 5D, can provide an engagement surface for the first end 90a of the pusher 90. Although element 90 is indicated as a pusher 90, one of ordinary skill in the art would understand that any linkage or connection could be provided between the carriage 72 and the pivot housing 27a that is configured to impart a pushing force or a pulling force (i.e. tensile force).

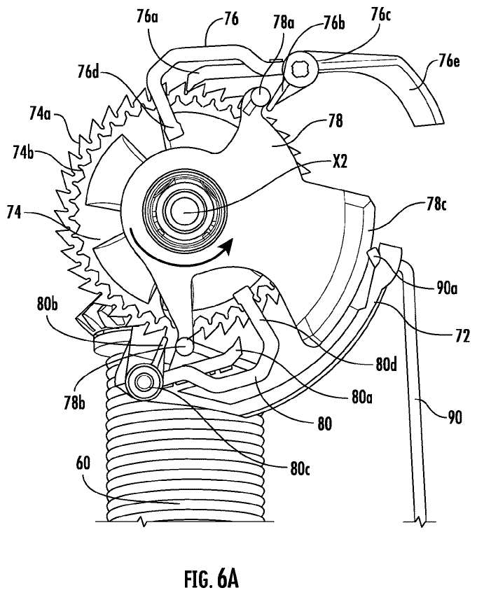

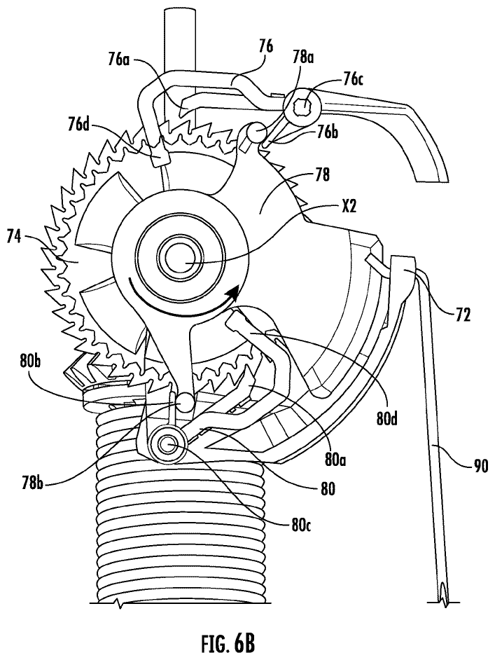

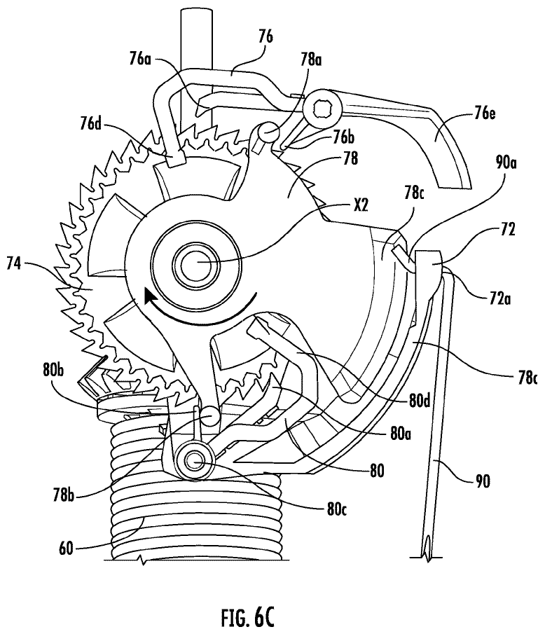

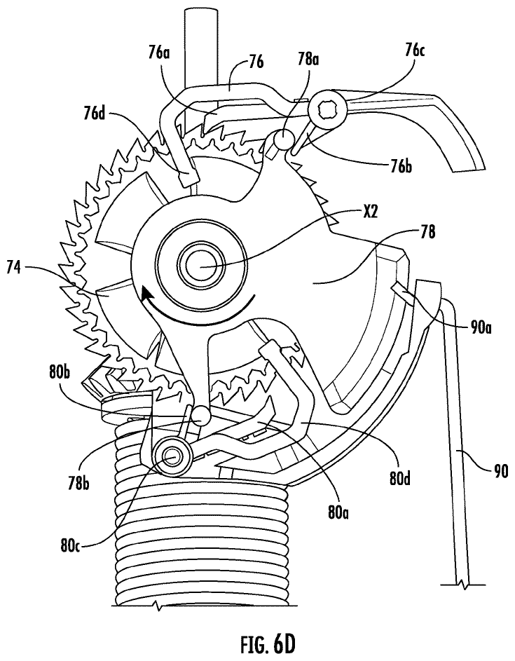

FIGS. 6A-6D illustrate various states for the windup swing assembly 10. FIG. 6A generally illustrates a non-powered phase, FIG. 6B illustrates a transition phase from a non-powered phase to a powered phase, FIG. 6C illustrates a powered phase, and FIG. 6D illustrates a transition phase from powered phase to non-powered phase.

FIG. 6A illustrates the escapement assembly 70 in a neutral position (i.e. non-powered phase) when the drive spring 60 is fully wound. As shown in FIG. 6A, the pawl tooth 76a is engaged with a tooth 74a of the escapement gear 74 to prevent the escapement gear 74 from rotating clockwise (due to energy from the wound drive spring 60), and also to prevent the drive spring 60 from unwinding inadvertently all at once. The dog engagement surface 78b on the actuator 78 and the dog control arm 80b are disengaged from each other during this state. FIG. 6A generally illustrates a non-powered state in which the dog 80 is fully disengaged, the pawl 76 is engaged, and rotation is configured to occur in the counter-clockwise direction for the actuator 72.

FIG. 6B illustrates the swing arm assembly 12 and the carriage 72 rotating counterclockwise due to the swing arm assembly 12 being initially pushed by a user. This movement is counter to the spring force from the drive spring 60 which normally drives the swing arm assembly 12 to rotate in the clockwise direction. As shown in FIG. 6B, inertia from an initial push causes the swing arm assembly 12 to move in the counterclockwise direction and drives the pusher 90, which then drives the carriage 72 to start rotating in the counterclockwise direction. This movement of the carriage 72 also drives the dog 80 counterclockwise. Movement of the dog 80 in the counterclockwise direction causes the dog control arm 80b to engage the dog engagement surface 78b of the actuator 78. This engagement causes the dog 80 to rotate about the dog pivot 80c, and the dog tooth 80a is driven into engagement with a tooth 74a of the escapement gear 74. Inertia from the swing arm assembly 12 is applied to the dog tooth 80a such that the torque from the drive spring 60 is now between the seat frame (i.e. upright frame member 35c) on one end and the dog 80 on the other end. Since the dog 80 is connected to the carriage 72, any movement imparted from the swing arm assembly 12 to the carriage 72 also drives the dog 80. The engaged dog 80 then rotates the escapement gear 74 counterclockwise, and relieves the forces on the pawl 76.

The pawl 76, which is biased by gravity due to the pawl weight 76e, then rotates clockwise and disengages from the escapement gear 74. During this phase, the torque force from the escapement gear 74 that was applied to the pawl 76 is released and the pawl 76 temporarily disengages from the escapement gear 74. The dog 80, now being engaged in the escapement gear 74, transmits the spring torque from the escapement gear 74 into the carriage 72 thereby providing energy to drive the swing arm assembly in a counterclockwise pendulum motion.

FIG. 6C illustrates a power stroke phase in which the swing arm assembly 12 is rotating clockwise. During this phase, the drive spring 60 is applying a force that drives the escapement gear 74 in the clockwise direction. During this phase, the pawl 76 is disengaged from the escapement gear 74, and the dog 80 is engaged with the escapement gear 74. The escapement gear 74 is configured to drive the dog 80 to rotate clockwise, which in turn then drives the carriage 72 clockwise. The carriage 72, which is fixed to the pusher 90, then imparts this driving motion through the pusher 90 to the swing arm assembly 12, thereby powering the pendulum motion. During this phase, the pawl 76 remains disengaged, which is necessary such that the escapement gear 74 can rotate in the clockwise direction. The dog 80 remains in contact with the actuator 78 as the dog 80 rotates clockwise. Based on this engagement, the dog 80 is configured to control the timing of the clockwise rotation of the actuator 78. The actuator 78 is generally biased to rotate clockwise due to gravity (i.e. due to the actuator weight 78c), and the dog 80 controls that rotation until the actuator 78 engages the pawl 76.

Referring to FIG. 6D, as the swing assembly transitions from a powered phase to a non-powered phase, the actuator 78 causes the pawl 76 to engage the escapement gear 74 (i.e. via engagement between the pawl engagement surface 78a and the pawl control arm 76b). During this phase, the carriage 72 continues to rotate clockwise, releasing the dog 80 from engagement with the actuator 78 (i.e. disengaging the dog engagement surface 78b from the dog control arm 80b) which allows the dog 80 to rotate clockwise about the dog pivot 80c to disengage from the escapement gear 74. After the actuator 78 causes the pawl 76 to drop into the next tooth 74a of the escapement gear 74, torque is transferred to the pawl tooth 76a as the pawl tooth 76a engages the escapement gear 74. During this step, the dog 80 drops out of engagement with the escapement gear 74 due to gravity (i.e. due to the shape of the dog and its pivot position). Power is therefore no longer being provided to the swing arm assembly 12 via the drive spring 60 even though the swing arm assembly 12 is still rotating in the clockwise direction. Shortly after the pawl tooth 76a engages the escapement gear 74, the pawl tooth 76a is no longer being held in place by the actuator 78. However, the pawl 76 controls the position of the actuator 78 and prevents the actuator 78 from rotating further clockwise due to gravity. The swing arm assembly 12 continues to swing clockwise for the remainder of the power stroke, and then the swing arm assembly 12 begins traveling counterclockwise. This occurs after the momentum ceases from the power stroke to the swing arm assembly 12.

As the swing assembly transitions back to a fully non-powered phase, the carriage 72 and the swing arm assembly 12 begin traveling counterclockwise, the dog 80 engages the actuator 78 and the actuator 78 causes the dog tooth 80a to rotate counterclockwise about the dog pivot 80c and into engagement with the next tooth of the escapement gear 74. After this step, the power stroke repeats.

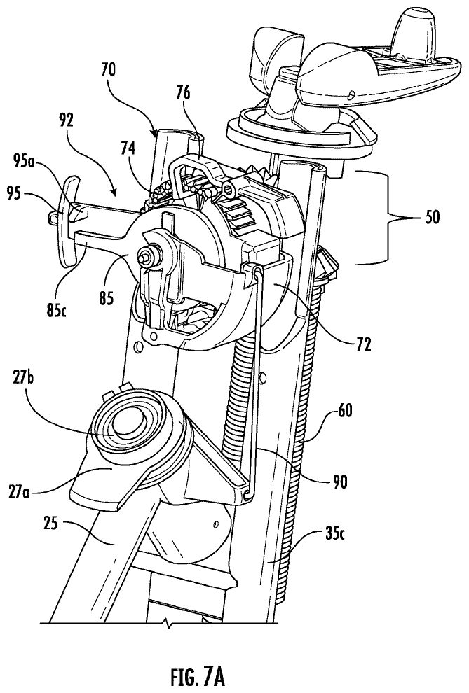

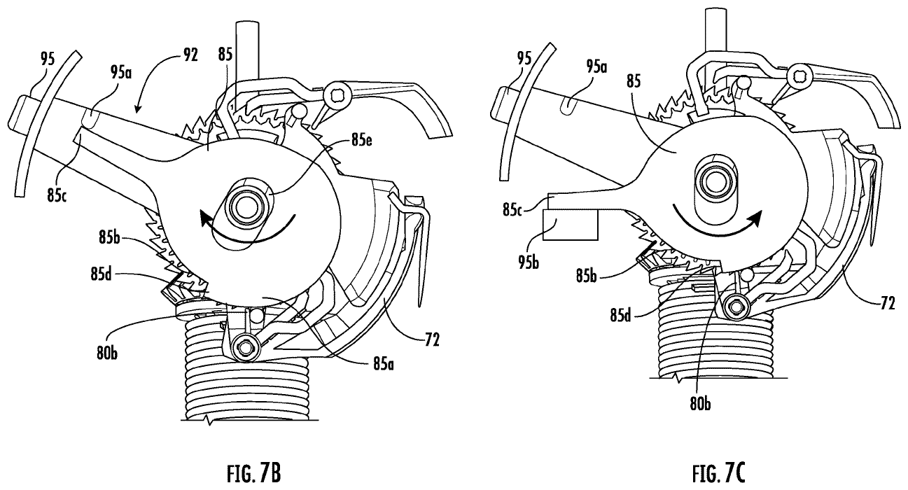

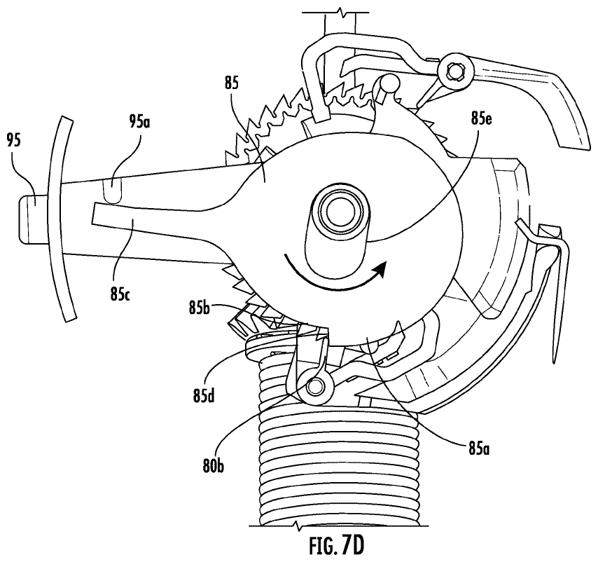

Referring to FIGS. 7A-7D, an amplitude control assembly 92 can be provided that generally controls the swing amplitude. The amplitude control assembly 92 can comprise a drop plate 85 configured to selectively limit a stroke of the dog 80, and an amplitude control lever 95 configured to selectively adjust a position of the drop plate 85. The amplitude control lever 95 can be configured to set the limit for the swing amplitude. If the actual swing amplitude begins to exceed the limit set by the amplitude control lever 95, then the amplitude control assembly 92 prevents the escapement assembly 70 from releasing additional energy from the drive spring 60 to the swing arm assembly 12.

The drop plate 85 can include an engagement portion 85a configured to engage with a portion of the dog 80 via a control edge 85d, a recessed portion 85b adjacent to the control edge 85d, and an appendage 85c configured to engage with a portion of the amplitude control lever 95. A user can manually engage the amplitude control lever 95 to adjust the swinging amplitude. The amplitude control lever 95 can include a first stop 95a and a second stop 95b that are spaced apart from each other. Each of the stops 95a, 95b can be configured to engage with the appendage 85c of the drop plate 85. The second stop 95b can be formed on a portion of the frame or housing, in one example.

The drop plate 85 is configured to rotate with the carriage 72 via frictional engagement between the engagement portion 85a of the drop plate 85 and the dog control arm 80b. Rotation of the drop plate 85 is limited by the first stop 95a and the second stop 95b. If the actual swing amplitude is within the predetermined limit set by the amplitude control assembly 92, then the dog 80 remains engaged with the engagement portion 85a of the drop plate 85, thereby preventing the drop plate 85 from dropping. The drop plate 85 includes a slot 85e through which the escapement shaft 75 is configured to extend, which allows the drop plate 85 to shift or drop. When the amplitude control lever 95 is rotated upwards or counterclockwise, then a greater amplitude for the swing is permitted. The appendage 85c of the drop plate 85 is permitted to rotate a greater distance between the stops 95a, 95b so that the dog control arm 80b remains in contact with the engagement portion 85a of the drop plate 85 longer as the swing arm assembly 12 swings higher. As long as the engagement portion 85a of the drop plate 85 is engaged with the dog control arm 80b, as shown in FIGS. 7B and 7C, then the drop plate 85 does not drop.

FIG. 7D shows the condition or phase in which the actual swing amplitude has exceed the predetermined or set limit. As shown in FIG. 7D, the drop plate 85 drops such that the dog control arm 80b engages beyond the control edge 85d and is received within the recessed portion 85b adjacent the control edge 85d. The control edge 85d of the drop plate 85 drives the dog tooth 80a into the same tooth 74a on the escapement gear 74 that it was previously engaged with instead of the next tooth 74a on the escapement gear 74. Therefore, the control edge 85d drives the dog tooth 80a into engagement with the escapement gear 74 before the actuator 78 would have otherwise driven the dog tooth 80a back into engagement with the escapement gear 74. Additionally, the control edge 85d of the drop plate 85 is angled so that is allows the dog control arm 80b to push the drop plate 85 upwards when swinging counterclockwise.

If the swing arm assembly 12 swings beyond the predetermined amplitude limit, the drop plate 85 drops down, causing the dog tooth 80a to engage the escapement gear 74 and then raise up. This is repeated for each swing cycle until the amplitude drops below the predetermined limit. The drop plate 85 drops down when the swing arm assembly 12 is traveling clockwise (i.e. the direction that the drive spring 60 is releasing its energy), and the dog control arm 80b is received into the recessed portion 85b of the drop plate 85.

The pawl tooth 76a and the dog tooth 80a are shown in various states with respect to the escapement gear 74, and more specifically with respect to a first set of toothing 74a on the escapement gear 74. A pawl safety tooth 76d and a dog safety tooth 80d are shown. A second set of toothing 74b on the escapement gear 74 is configured to be engaged with the pawl safety tooth 76d and the dog safety tooth 80d. The pawl safety tooth 76d and the dog safety tooth 80d are generally configured to engage with respective toothing among the second set of toothing 74b on the escapement gear 74 when winding the drive spring 60 to prevent the drive spring 60 from inadvertently unwinding. The dog safety tooth 80d can be configured to prevent the dog 80 from dropping too far when the dog 80 becomes disengaged from the escapement gear 74 during swinging.

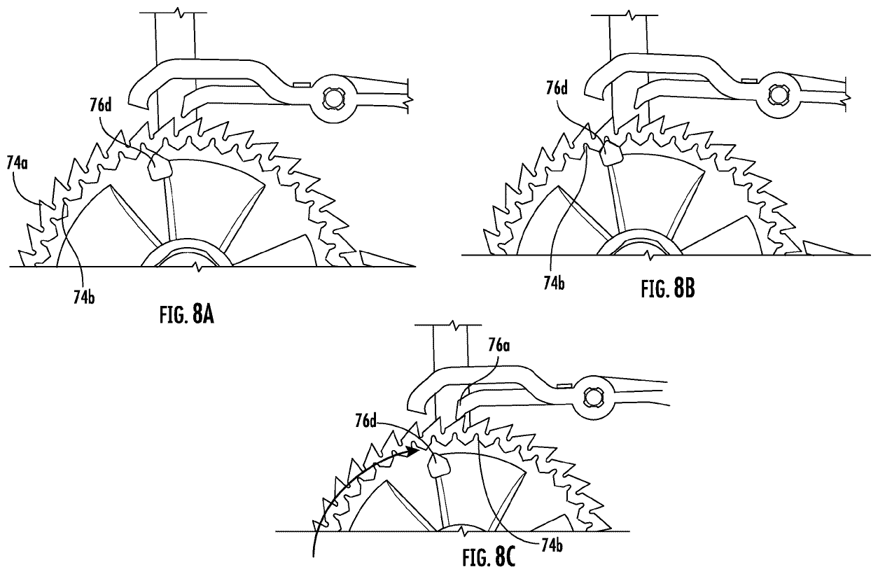

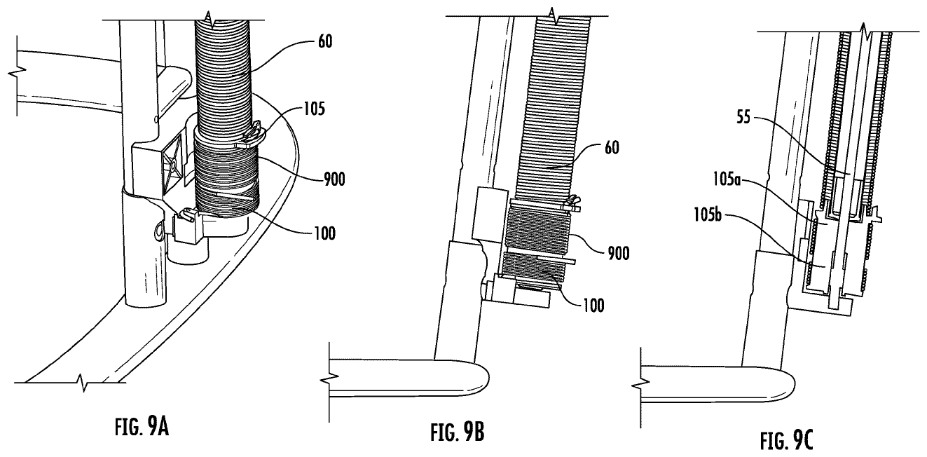

FIGS. 8A-8C illustrate further features of the pawl safety tooth 76d. One of ordinary skill in the art would understand the description provided herein regarding the function of the pawl safety tooth 76d would also apply to the dog safety tooth 80d. For illustrative purposes, a portion of the pawl 76 that supports the pawl safety tooth 76d is not illustrated in order to show the engagement between the pawl safety tooth 76d and the second set of toothing 74b on the escapement gear 74. During normal operation, the pawl safety tooth 76d and the dog safety tooth 80d generally follow the respective pawl tooth 76a and dog tooth 80a as the pawl tooth 76a and the dog tooth 80a are regularly driven inward and outward relative to the escapement gear 74. In the event of a potential failure of one of the components, such as the dog tooth 80a breaking, it is desired to have the pawl 76 reengage to prevent the high torque in the escapement gear 74 from the drive spring 60, regardless of actuator position and escapement mechanics. If the dog tooth 80a is inoperable, then the dog 80 cannot prevent any relative motion of the escapement gear 74 and there is a risk of high, uncontrolled torque from the drive spring 60 on the escapement gear 74 from being released. In this scenario, the second set of toothing 74b, beginning to rotate at high velocity, are configured to contact the pawl safety tooth 76d in a high velocity manner (as opposed to the usual counter-clockwise force created by gravity). This forcibly pulls the pawl tooth 76a down into voids between first set of toothing 74a, which is completely independent of any motion of the actuator 78, which usually controls motion of the pawl 76. The pawl tooth 76a is then driven towards the escapement gear 74 with considerable energy and momentum. The escapement gear 74 in this state is rotating in the clockwise direction with high velocity. Engagement of the pawl tooth 76a with the first set of toothing 74a stops the gear rotation. This same type of configuration would also occur in the event that the pawl tooth 76a becomes damages or otherwise fails and the dog safety tooth 80d must stop uncontrolled rotation of the escapement gear 74.

As an additional feature, a torque limiting clutch could also be implemented with the windup swing assembly 10 that is configured to prevent a user from winding the drive spring 60 beyond a predetermined torque limit. The torque limiting clutch can also be configured to slip if wound in the opposite or non-winding direction.

Referring specifically to FIGS. 9A-9C, a torque limiting clutch can be provided to prevent damage from excessive overwinding. The quiet wind spool 105 can be split into an upper portion 105a and a lower portion 105b in order to provide a torque limiting configuration for the drive spring 60. During winding, torque is transmitted from the lower portion 105b to the upper portion 105a by a torque clutch spring 900.

The torque clutch spring 900 is configured such that its inner diameter is less than the outer diameter of the quiet wind spool 105 prior to being assembled on the quiet wind spool 105. The torque clutch spring 900 is assembled on to the upper and lower portions 105a, 105b portions of the quiet wind 105 spool by temporarily enlarging the inner diameter of the torque spring 900. This is accomplished by applying a torque force to the torque clutch spring 900. Once assembled to the quiet wind spool 105, the torque force is removed and the torque spring 900 grips the upper and lower portions 105a, 105b of the quiet wind spool 105. This tightening of the torque clutch spring 900 on the quiet wind spool portion 105 allows torque to be transmitted from the lower portion 105b to the upper portion 105a.

During winding, torque from the wind shaft 55 turns the lower portion 105b. This torque is then transmitted to the upper portion 105a, and rotation of the upper portion 105a winds the drive spring 60. The coil wind direction of torque clutch spring 900 is such that when transmitting winding torque, the coils of the torque clutch spring 900 are configured to slip at a given or predetermined torque. However, when resisting the torque of the fully wound drive spring 60, the torque clutch spring 900 locks the upper portion 105a to the lower portion 105b of the quiet wind spool 105. The torque is then further resisted by the slip clutch spring 100 connection of the lower portion 105b and the pin 102.

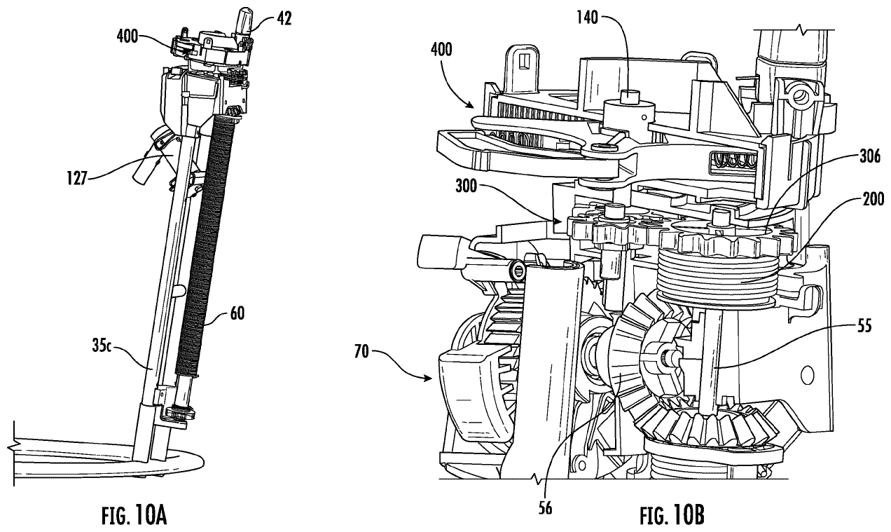

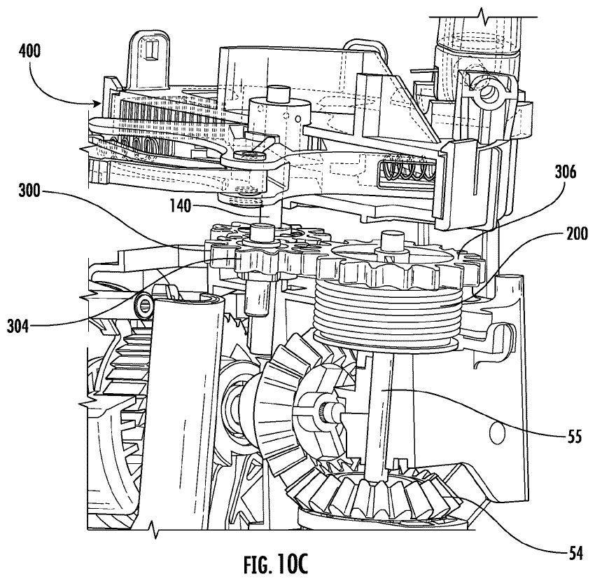

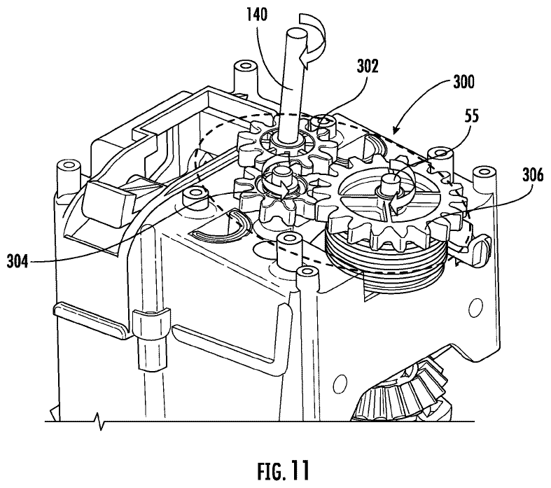

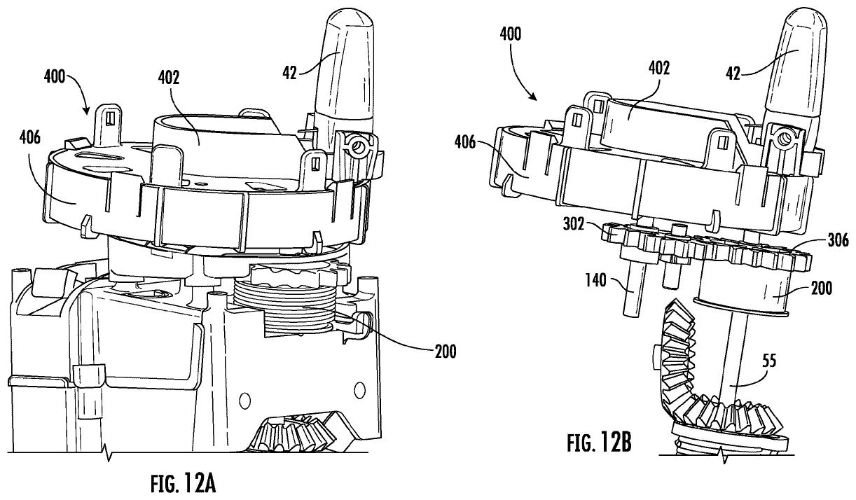

One of ordinary skill in the art would understand that various modifications can be made to the windup swing assembly. For example, as shown in FIGS. 10B, 10C, and 11, in one configuration, a gear assembly 300 can be incorporated in order to facilitate easier winding up of the swing. The gear assembly 300 can comprise a plurality of gears. For example, a crank gear 302 can be connected to a shaft 140 that is connected to the crank assembly 40. The crank gear 302 can be directly engaged with a spring gear 306, in one example. In one example, an idler or intermediary gear 304 can be arranged between the crank gear 302 and the spring gear 306. The spring gear 306 can be rotationally fixed with the wind shaft 55. The idler gear 304 can be provided to maintain rotation of the user input/rotation and spring winding. The gear assembly 300 reduces the force required for a user to apply to the crank assembly 40, and also allows the crank assembly 40 to be centrally located relative to the housing. One of ordinary skill in the art would understand that the crank assembly 40 does not need to be centrally located and can be positioned in a variety of locations. The shaft 140 connected to the crank assembly 40 can generally have a rotational axis that is more centrally positioned, while the rotational axis of the wind shaft 55 is offset from the rotational axis of the shaft 140. While one specific gear configuration is shown, one of ordinary skill in the art would understand that various gear configurations can be used that both make winding the swing up easier, and also positions the crank assembly 40 in a more desirable location of the housing for stability and weight distribution purposes.

A torque limiting clutch assembly 400 can also be provided, as shown in more detail in FIGS. 12A-12G. The torque limiting clutch assembly 400 can include a first housing 402 that is configured to support a portion of the crank assembly 40, such as the grip 42. The first housing 402 can be considered an upper housing or portion. The first housing 402 can include clutch driver toothing 402a. A second housing 406 can be provided that can function as a cover or lower portion of the torque limiting clutch assembly 400. The second housing 406 can be omitted in some embodiments.

A clutch hub 404 is also provided that is configured to interact or engage with the first housing 402, and more specifically with the clutch driver toothing 402a. The clutch hub 404 can be rotationally locked with the crank assembly 40. The clutch hub 404 can include at least one pawl 404a. The at least one pawl 404a can include two pawls, in one example. The pawl 404a can include at least one pawl tooth 404b, which can be configured to selectively engage with the clutch driver toothing 402a. The clutch hub 404 can further include a biasing element 404c that is configured to pivot or drive the pawl 404a outward such that the pawl tooth 404b engages with the clutch driver toothing 402a. In one example, the biasing element 404c can include springs. A pivot connection 404d can be provided at one end of the at least one pawl 404a to attach the pawl 404a to a body of the clutch hub 404.

Torque is applied to the first housing 402, thereby causing the clutch driver toothing 402a to engage with the pawl tooth 404b. The pawl 404a is configured to be driven clockwise via contact between the clutch driver toothing 402a and the pawl tooth 404b. Torque is thereby transmitted from the crank assembly 40 to the drive spring 60. The pawl 404a is generally biased radially outward via the biasing element 404c. At a given or predetermined torque, the force of the biasing element 404c is overcome by the winding torque that is being applied to the crank assembly 40. When this occurs, the pawl 404a rotates clockwise thereby causing the pawl tooth 404b to disengage from the clutch driver toothing 402a. Accordingly, no more torque is transmitted from the crank assembly 40 to the drive spring 60. This prevents overwinding of the system that can possibly damage components of the crank assembly 40, the drive spring 60, and the associated components.

As shown in FIGS. 12D and 12E, an arrow is shown indicating the winding torque applied by a user. During this state, the pawl tooth 404b and the clutch driver toothing 402a are engaged. As shown in FIG. 12F, the pawl tooth 404b and the clutch driver toothing 402a become disengaged in the event that a user is applying too much torque to the crank assembly 40. In this condition, torque is not transmitted from the crank assembly 40 to the drive spring 60 due to the torque limiting clutch assembly 400 becoming disengaged. The torque limiting clutch assembly 400 is configured to ensure that the applied torque or input to the windup swing assembly does not exceed a predetermined amount of torque. As shown in more detail in FIG. 12G, the first housing 402 also defines a plurality of secondary teeth 404e that are configured to allow a nose of the pawl 404a to ride over the secondary teeth 404e and emit an audible noise that the clutch is disengaged due to too much input torque being input to the system. The pawl tooth 404b is configured to catch the clutch driver toothing 402a as the first housing 402 and the clutch hub 404 continue rotating for a predetermined circumferential extent, such as 180 degrees.

FIGS. 12H and 12I illustrate an alternative aspect of a torque limiting clutch 400′, according to an aspect of this disclosure. The torque limiting clutch 400′ can be implemented with the windup swing assembly 10 to prevent a user from winding the drive spring 60 beyond a predetermined torque limit. The torque limiting clutch 400′ is positioned between an input shaft 402′ and an output shaft 404′. The input shaft 402′ is operably connected to the crank assembly 40, and the output shaft 404′ is operably connected to the drive spring 60. The torque limiting clutch 400′ can further include a cap 406′, a spool 408′, and a spring 410′. The cap 406′ is fixed to the input shaft 402′ and the spool 408′ is fixed to the output shaft 404′. The cap 406′ and spool 408′ are clamped together via the spring 410′, and can slip relative to one another when a friction force is overcome. The slip between the cap 406′ and the spool 408′ can prevent the drive spring 60 from being overwound.

FIGS. 12J-12M illustrate an alternative aspect of a torque limiting clutch assembly 420 according to an aspect of this disclosure. The torque limiting clutch assembly 420 illustrated in FIGS. 12K-12M operates similar to the torque limiting clutch assembly 400 illustrated in FIGS. 12A-12G, but requires fewer components which can reduce size and cost of the torque limiting clutch assembly 420, and also reduce the potential for mechanical issues and improper assembly. The torque limiting clutch assembly 420 can include an input hub 422 and an output hub 424. The output hub 424 can be rotationally locked to the shaft 140. The input hub 422 can be considered an upper portion and can support a portion of the crank assembly 40, such as the grip 42. The input hub 422 can include at least one catch 426 to engage at least one protrusion 428 of the output hub 424. The at least one catch 426 can be, for example, a resilient material such as a spring finger 430 having an engagement portion 432, such as an engaging orifice or engaging surface, configured to engage the at least one protrusion 428 of the output hub 424.

The input hub 422 can be rotationally locked with the crank assembly 40. The output hub 424 can be positioned within a lower portion of the input hub 422. The at least one catch 426 of the input hub 422 can be biased to engage the at least one protrusion of the 428 of the output hub 424. Torque applied to the input hub 422 causes the at least one catch 426 to engage the at least one protrusion 428. Torque is thereby transmitted from the crank assembly 40 to the drive spring 60. At a given or predetermined torque, the force of the catch 426 is overcome by the winding torque that is being applied to the crank assembly 40. When this occurs, the protrusion 428 slips or disengages from the catch 426 to prevent torque from being transmitted from the crank assembly 40 to the drive spring 60. This prevents over winding of the drive spring 60 that can possibly damage components of the crank assembly 40, the drive spring 60, and the associated components.

FIGS. 12J-12M illustrate the input hub 422 having three catches 426 and the output hub 424 having three protrusions 428; however, one of skill in the art will recognize that other variations on the number of catches 426 and protrusions 428 can be utilized within the scope of this disclosure. In addition, one of skill in the art will recognize that the placement of the at least one catch 426 and the at least one protrusion 428 can be reversed such that the at least one protrusion 428 is positioned on the input hub 422 and the at least one catch 426 is positioned on the output hub 424.

FIGS. 12N-12Q illustrate an alternative aspect of a torque limiting clutch assembly 440 according to an aspect of this disclosure. The torque limiting clutch assembly 440 can include an input hub 442 and an output hub 448. The output hub 424 can be rotationally locked to the shaft 140. The input hub 442 can include upper portion 444 and a lower portion 446. The upper portion 444 can support a portion of the crank assembly 40, such as the grip 42. The output hub 448 can be positioned beneath the upper portion 444 of the input hub 442. The output hub 448 can include an upper portion 450 and a lower portion 452. In an example, the upper portion 450 and the lower portion 452 of the output hub 448 can be positioned within the upper portion 444 and the lower portion 446 of the input hub 442.

The input hub 442 can include at least one catch 454 having an engagement surface 455 to engage at least one protrusion 456 of the output hub 448. The at least one catch 454 can be, for example, pivotally attached to the input hub 442 or a resilient portion of the input hub 442. A spring 458 can be attached to the at least one catch 454 to bias the catch 454 inwardly toward the output hub 448. In an example, the input hub 442 includes two catches 454, the output hub 444 includes two engage two protrusions 456, and the spring 458 biases the engagement surface 455 of each catch 454 toward engagement with the protrusions 456.

The input hub 442 can be rotationally locked with the crank assembly 40. Torque applied to the input hub 442 causes the engaging surface 455 of the at least one catch 454 to engage the at least one protrusion 456. Torque is thereby transmitted from the crank assembly 40 to the drive spring 60. At a given or predetermined torque, the biased force of the catch 454 is overcome by the winding torque that is being applied to the crank assembly 40. When this occurs, the protrusion 456 slips or disengages from the engaging surface 455 of the catch 454 to prevent torque from being transmitted from the crank assembly 40 to the drive spring 60. This prevents over winding of the drive spring 60 that can possibly damage components of the crank assembly 40, the drive spring 60, and the associated components.

FIGS. 12N-12Q illustrate the input hub 442 having two catches 454 and the output hub 448 having two protrusions 456; however, one of skill in the art will recognize that other variations on the number of catches 454 and protrusions 456 can be utilized within the scope of this disclosure. In addition, one of skill in the art will recognize that the placement of the at least one catch 454 and the at least one protrusion 456 can be reversed such that the at least one protrusion 456 is positioned on the input hub 442 and the at least one catch 454 is positioned on the output hub 448.

As shown in FIG. 14, a swing arm hub 22 can be provided that is connected to the swing arm 25 and also the first and second ends 25a, 25b of the swing arm 25. An axis of recline (AR) is defined based on the angle of the adjustment assembly 20, and an axis of seat rotation (ASR) is defined that generally extends perpendicular to the swing arm hub 22. A center of gravity (COG) scatter plot is also illustrated in FIG. 14. The center of gravity (COG) is generally determined based on the weight distribution of the frame itself, as well as the occupant or child in the swing. In general, the windup swing assembly 10 provides an improved configuration which is easier to use that swings for a longer duration and more smoothly with a more predictable amplitude than other known swing assemblies. The axis of recline (AR) and the axis of seat rotation (ASR) intersect with each other and both generally extend through the center of gravity (COG). A schematic for an occupant is shown in FIG. 14. One of ordinary skill in the art would understand that soft goods or a seat assembly can be provided for supporting the occupant. The weight of the occupant is generally positioned in such an area of the seat frame 15 that the center of gravity (COG) is intersected by both the axis of recline (AR) and the axis of seat rotation (ASR). One of ordinary skill in the art would understand that various design considerations can be adjusted or modified, such as the shape of the seat frame 15, length/angle of the swing arm 25, profile of the soft goods, etc. The configuration shown in FIG. 14 improves the stability of the windup swing assembly 10 based on the positioning of the axis of recline (AR) and the axis of seat rotation (ASR), as well as the center of gravity.

FIGS. 15A-15C illustrate additional aspects or features for the swing arm 25 and its interface with the swing arm pivot 127. A swing arm connector 125 can be provided that has a first end secured to the swing arm pivot 127 and is configured to be attached or connected to the swing arm 25. For example, the swing arm 25 can be received within the swing arm connector 125 and further secured via a rivet 125a, and a snap pin 125b. The snap pin 125b can be provided on the swing arm 25 and can be configured to be received within an opening on the swing arm connector 125. The rivet 125a can extend through an opening on the swing arm connector 125 and within a slot 125c defined on the swing arm 25. This connection arrangement reduces or limits any play or loose connections between the swing arm 25 and the swing arm pivot 127, thereby providing an improved swing time. Additionally, the connection allows for a user to quickly and easily remove the swing arm 25 from the swing arm pivot 127 for disassembly. The snap pin 125b can prevent removal of the two components form each other, and the rivet/slot connection minimizes torsional and rotational movement between the swing arm 25 and the swing arm pivot 127.

The windup swing assembly 10 disclosed herein generally provides a small footprint, that lacks any overhead or vertical support, and requires a very limited energy source to drive a swing arm assembly. The windup swing assembly 10 disclosed herein also provides an improved and efficient configuration for transferring forces between multiple axes (i.e. the swing arm axis (X1), the escapement axis (X2), and the drive spring axis (X3)). This configuration imparts pendulum-like motion of the swing arm through the use of bearings in order to overcome wind resistance and increase running time for the windup swing assembly 10. The windup swing disclosed herein also has a longer run time, which can exceed 45 minutes-60 minutes based on a user winding the drive spring for approximately 20 seconds, or approximately 20-30 winds.

FIGS. 16-27 illustrate an alternate aspect of a windup swing assembly 600, according to aspects of this disclosure. Portions of the alternate aspect of the windup swing assembly 600 disclosed in FIGS. 16-27 are similar to aspects of the windup swing assembly 10 described above in FIGS. 1-15 and those portions function similarly to those described above. The windup swing assembly 600 includes a swing arm assembly 612 comprising a seat frame 615 and a swing arm 625 connected to a swing arm pivot 627. The windup swing assembly 600 further includes a frame assembly 635 and a crank assembly 640.

The swing arm 625 extends between the swing arm pivot 627 and the seat frame 615. A swing arm 625 forms an approximate L-shape. The shape and position of the swing arm 625 can alleviate safety concerns by minimizing the potential of a hand, finger, leg, or head of a child from getting stuck between the swing arm 625 and the seat frame 615. It will be appreciated that the swing arm 625 can include other shapes to affect the spacing between the swing arm 625 and the swing frame 615 for safety concerns.

The configuration of the connection of the swing arm 625 and the frame assembly 635 allows for easy access to a seat on the seat frame 615. For example, there is no structure immediately above the seat frame 615 (see FIG. 16B). This configuration creates an open access that allows a caregiver to place and remove a child from the swing assembly 600. It will be appreciated that a movable toy bar or other movable or removable play toy can be included on the seat frame 615 without hindering the open access to the seat on the seat frame 615.

The crank assembly 640 includes a crank arm 644, a ring 646, and a plate 648. The ring 646 extends about a periphery of the plate 648, and can be fixed to the swing frame 615. The crank arm 644 is connected to the plate 648 such that rotation of the crank arm 644 causes rotation of the plate 648. The crank arm 644 and the plate 648 can rotate about the same rotational axis. Rotation of the crank arm 644 can wind the drive spring 60. During operation (as described further below), as a user winds the crank arm 644 to wind the drive spring 60, the user can grip the ring 646 to facilitate the winding motion.

The crank arm 644 can have a curved or rounded shape, and can rotate down towards the plate 648. In an aspect, the crank arm 644 can rotate down into a recess or opening defined by the plate 648. The capability to rotate down and the shape of the crank arm 644 can minimize “catch” (e.g. strings, clothing, or other material from getting caught or tangled in the crank arm 644 area).

FIGS. 18-26 illustrate alternate aspects of a swing arm assembly and seat assembly 740, according to aspects of this disclosure. The swing arm assembly 712 includes a swing arm 725 and a support hub 727. The swing arm 725 can extend between the swing arm pivot 627 and the support hub 727. The seat assembly 740 includes a seat frame 715, a seat portion 717, and a base assembly 719. The seat assembly 740 can be detachably connected to the support hub 727 (see FIGS. 19 and 20).

Referring to FIGS. 21A through 21D, the support hub 727 can include a rotation hub 750 and a stationary hub 752. The stationary hub 752 can be fixedly connected to the swing arm 725. The rotation hub 750 can be rotatably connected to the stationary hub 752 such that the rotation hub 750 can rotate relative to the stationary hub 752 about a rotation axis A. The rotation hub 750 includes a rotation body 754 that extends upward from a rotation base 753. The rotation body 754 is configured to receive the seat assembly 740 thereon. The rotation body 754 defines a circular depression 756 and at least one anti-rotation channel 758. The circular depression 756 can be positioned in a center of the rotation body 754. In an aspect, a center of the circular depression 756 can be located on the rotation axis A. The rotation body 754 further includes at least one latch ledge 760. The at least one latch ledge 760 can be positioned within the at least one anti-rotation channel 758. It will be appreciated that the at least one latch ledge 760 can be positioned at other locations on the rotation hub 750. In an aspect, the rotation body 754 includes four anti-rotation channels 758 and four latch ledges 760 positioned within respective anti-rotation channels 758. It will be appreciated that the rotation body 754 can include fewer or more anti-rotation channels 758 and latch ledges 760.

Referring to FIGS. 21C and 21D, the support hub 727 can further include a plunger 762 and biasing element 764. The biasing element can be an elastic member, for example, such as a spring. The plunger 762 and biasing element 764 can be positioned at least partially between the rotation hub 750 and the stationary hub 752. The rotation hub 750 can define at least one plunger recess or detent 766. The shape and configuration of the at least one plunger recess 766 corresponds to the plunger 762, such that the plunger 762 can be received with the at least one plunger recess 766. The connection between the plunger 762 and the at least one plunger recess 766 creates a temporary rotational lock between the rotation hub 750 and the stationary hub 752. The temporary rotational lock can be overcome by applying a rotational force to the rotation hub 750 to force the biasing element 764 to retract the plunger 762 out of the at least one plunger recess 766. The rotation hub 750 can include four plunger recesses 766 spaced circumferentially about the rotation hub 750. It will be appreciated that the rotation hub 750 can include fewer or more than four plunger recesses 766. In an aspect, the plunger recesses 766 can be spaced equidistant from each other about the rotation hub 750.

With reference to FIG. 22, the seat assembly 740 further includes at least one support leg 768, a support base 770, and a connection assembly 772. The at least one support leg 768 extends upward from the support base 770, and is configured to support the seat frame 715 and the seat portion 717 above the support base 770. As illustrated, the at least one support leg 768 includes two legs. It will be appreciated that the at least one support leg 768 can include fewer or more legs. The support base 770 can define, for example, a rocker, a flat surface, or other shape such that the seat assembly 740 attached to the support base 770 can be used independently of the swing arm assembly 712 and placed for use on a surface (e.g. a floor, a countertop, etc.).

The connection assembly 772 is connectable to the support hub 727. With reference to FIGS. 23A and 23B, the connection assembly 772 defines a connection recess 776. The connection recess 776 is sized to receive the support hub 727 within to connect the seat assembly 740 to the swing arm 725. In an aspect, the connection recess 776 defines a shape that approximately corresponds to a shape of an outer surface of the rotation body 754.

The seat assembly 740 further includes at least one actuator 774. The at least one actuator 774 can control a release connection between the connection assembly 772 and the support hub 727, as further described below. The at least one actuator 774 can be connected to at least one of the at least one support leg 768, the support base 770, and the connection assembly 772.

FIGS. 24A and 24B illustrate a connection assembly 872 and a support hub 827, according to alternative aspects of this disclosure. The connection assembly 872 can include at least one connection recess 874. The support hub 827 can include at least one connection stud 829. When the connection assembly 872 is positioned on the support hub 827, the at least one connection stub 829 can be received within the at least one connection recess 874. The connection between the at least one connection stub 829 and the at least one connection recess 874 provides a further rotational lock (e.g. torque lock) between connection assembly 872 and the support hub 827. By reducing the movement between the connection assembly 872 and the support hub 827, less energy is wasted during operation of the swing assembly 600. It will be appreciated that the at least one stud 829 and the at least one recess 874 can be positioned on either one of the connection assembly 872 and the support hub 827. For example, the support hub 827 can include the at least one recess 874, and the connection assembly 872 can include the corresponding at least one stud 829.

FIGS. 25-27 illustrate a cross section of the at least one actuator 774 and a portion of the connection assembly 772. The connection assembly 772 comprises an actuator biasing element 777, a pivot member 778, and a hub latch 780. The connection assembly 772 further defines a hub protrusion 782 and at least one anti-rotation rib 784 within the connection recess 776. The at least one anti-rotation rib 784 is sized to be received within a corresponding at least one anti-rotation channel 758 of the rotation hub 750. The connection of the at least one rib 784 within the at least one anti-rotation channel 758 substantially prevents rotation between the connection assembly 772 and the rotation hub 750. It will be appreciated that the rotation hub 750 can include at least one rib and the connection assembly 772 includes at least one channel configured to receive the at least one rib. The hub protrusion 782 is sized to be received with the circular depression 756 of the rotation hub 750.

The actuator biasing element 777 can be, for example, an elastic member such as a spring, and is connected between the at least one actuator 774 and the pivot member 778. The pivot member 778 can be, for example, a pivot shaft or pivot latch, and is pivotally connected to a body 772a of the connection assembly 772 at a pivot connection 779. The pivot member 778 is further connected between the biasing element 777 and the hub latch 780. A first end 778a of the pivot member 778 is connected to the at least one actuator 774 and under a biasing force of the biasing element 777. A second end 778b of the pivot member 778 is connected to the hub latch 780 and biases the hub latch 780 into a locked position, such that the hub latch 780 can engage the rotation hub 750. The hub latch 780 can be pivotally connected to the body 772a of the connection assembly 772. Actuation of the actuator 774 or movement of the at least one actuator 774 into an actuated position causes the hub latch 780 to transition between an unlocked position (FIG. 26) and a locked position (FIG. 27). For example, with reference to FIG. 26, as the actuator 774 is actuated (e.g. moved upward in the view shown in FIG. 26), the actuator 774 overcomes a biasing force of the biasing element 777 and causes the pivot member 778 to pivot about the pivot connection 779. The pivot movement of the pivot member 778 transitions the hub latch 780 from the locked position to the unlocked position. When the at least one actuator 774 is released, the biasing element 777 pulls the at least one actuator 774 downward and causes the pivot member 778 to rotate about the pivot connection 779 which causes the hub latch 780 to transition to the locked position.

With reference to FIG. 27, the hub latch 780 is in the locked position and the rotation hub 750 is positioned within the connection recess 776. The hub latch 780 is in the locked position and engaged with the at least one latch ledge 760 of the rotation hub 750. The engagement between the at least one latch ledge 760 and the hub latch 780 substantially locks the seat assembly 740 to the rotation hub 750. To remove the seat assembly 740, the at least one actuator 774 can be actuated to transition the hub latch 780 to the unlocked position. In the unlocked position, the seat assembly 740 can be removed from the rotation hub 750.

A method of using a windup swing assembly 10 is also disclosed. It will be appreciated that the method of using the windup swing assembly 10 can also be used to operate the windup swing assembly 600. The method can include engaging a crank assembly 40 by rotating a crank handle 44. The crank assembly 40 is operatively connected to a wind mechanism 50 such that rotational input from the crank assembly 40 is imparted to the wind mechanism 50. Rotating the crank handle 44 results in winding a drive spring 60 that is connected to the wind mechanism 50. The method includes selectively releasing energy from the drive spring 60 via an escapement assembly 70 which can include a carriage 72. The carriage 72 can also be linked to a swing arm pivot 27 via a pusher 90. Based on this arrangement, the swing arm pivot 27 moves, i.e. is driven, in a first direction during a power stroke due to a discrete release of energy from the drive spring 60 via the escapement assembly 70. The swing arm pivot 27 moves in a second direction, opposite from the first direction, during a non-power stroke. This movement in the second direction is based on momentum or gravity. The swing arm pivot 27 is configured to sway side to side based on the energy from the drive spring 60, as opposed to swinging in a forward to backward direction.

A method of driving a seat frame 15 of a windup swing assembly 10 is also disclosed herein. It will be appreciated that the method of driving the seat frame 15 of the windup swing assembly 10 can also be used to operate the windup swing assembly 600. The method can include rotating a crank assembly 40 that is connected to a drive spring 60 such that the drive spring 60 becomes wound. The drive spring 60 can have a drive spring axis (X3) that is oriented in a non-vertical direction. The method includes transferring energy from the wound drive spring 60 to an escapement assembly 70, which can have an escapement axis (X2) that is angled relative to the drive spring axis (X3). The method can include selectively releasing energy from the escapement assembly 70 to a swing arm pivot 27. The swing arm pivot 27 can be connected to the seat frame 15 and can have a swing arm axis (X1) that is angled relative to the drive spring axis (X3) and the escapement axis (X2).

The windup swing assembly 10 disclosed herein also provides an enhanced run time or swing time as compared to known non-electric or manually powered swing assemblies. For example, a run time of approximately one hour can be provided by the windup swing assembly disclosed herein. This runtime is based on a user cranking the windup assembly for approximately 20 seconds, or approximately 20-30 winds.

The windup swing assembly 10 disclosed herein provides a reduced footprint as compared to known windup swing assemblies, while also providing improved accessibility to the seat frame in which the child is supported. As shown in the Figures, the drive spring 60 is arranged in a non-overhead position relative to the seat frame. This provides multiple advantages, including unobstructed access to the seat frame and the child, and also provides a desirable center of gravity by placing the drive spring 60 relatively closer to the ground surface as compared to windup swing assemblies that require the drive spring 60 to be arranged overhead relative to the seat frame. Based on this orientation, the center of gravity is lower to the ground and therefore a relatively smaller support assembly is required for the frame.

The above-described swing assembly may be implemented in various configurations and operated with various methods which are listed below:
1. A windup swing assembly comprising: a frame assembly comprising a housing; a drive spring positioned within the housing and having a drive spring axis (X3) oriented in a non-vertical direction relative to a vertical plane; and a swing arm assembly connected to the frame assembly to receive energy from the drive spring, the swing arm assembly including a swing arm and a swing arm pivot, the swing arm is rotatable about a swing arm axis (X1) that is oriented in a non-horizontal direction relative to a horizontal plane.
2. The windup swing assembly of configuration 1, wherein the drive spring axis (X3) is angled relative to the swing arm axis (X1).
3. The windup swing assembly of configuration 1, wherein the swing arm axis (X1) is oriented at angle of 30-70 degrees relative to the horizontal plane.
4. The windup swing assembly of configuration 1, wherein the drive spring axis (X1) is oriented at angle of 5-20 degrees relative to the vertical plane.
5. The windup swing assembly of configuration 1, further comprising an escapement assembly connected to the frame assembly having an escapement axis (X2) that is angled relative to the swing arm axis (X1).
6. The windup swing assembly of configuration 5, wherein the swing arm axis (X1), the escapement axis (X2), and the drive spring axis (X3) are each angled relative to one another.
7. The windup swing assembly of configuration 5, wherein the escapement axis (X2) is substantially parallel to the substantially parallel to the horizontal plane.
8. The windup swing assembly of configuration 1, wherein the swing arm assembly includes an adjustment assembly and a seat frame, and the adjustment assembly is configured to adjust a recline angle of the seat frame.
9. The windup swing assembly of configuration 8, wherein the drive spring is arranged laterally relative to the seat frame.
10. The windup swing assembly of configuration 1, wherein the frame assembly comprises: an upper end and a lower end; a base is positioned at a lower end of the frame assembly; and an upright frame member extending from the base to the upper end of the frame assembly.
11. The windup swing assembly of configuration 10, wherein the frame assembly further comprises: a support positioned at the lower end of the frame assembly, the support configured to rest on a ground surface, and a handle positioned adjacent the upper end of the frame assembly.
12. The windup swing assembly of configuration 11, wherein the support extends in an opposite direction from the base.
13. The windup swing assembly according of configuration 1, wherein a crank assembly is provided on the frame assembly to wind the drive spring.
14. The windup swing assembly of configuration 13, wherein the crank assembly comprises a crank handle that is configured to extend away from the frame assembly, and rotation of the crank handle about a crank pivot winds the drive spring.
15. The windup swing assembly of configuration 14, wherein the crank handle is configured to fold outward from the frame assembly in a use condition and is configured to fold into a pocket defined on the frame assembly in a storage condition.
16. The windup swing assembly of configuration 13, further comprising a wind mechanism arranged between the crank assembly and the drive spring to translate cranking input from the crank assembly to wind the drive spring.
17. The windup swing assembly of configuration 16, wherein: the wind mechanism comprises a wind shaft connected to the crank assembly at a first end and connected to a spool at a second end; and the drive spring includes a first end connected to an attachment plate arranged around the wind shaft and a second end connected to the spool, such that rotation of the wind shaft winds the drive spring via the spool.
18. The windup swing assembly of configuration 17, further comprising a gear assembly arranged between the crank assembly and the drive spring to reduce a force required to wind the drive spring, the gear assembly comprising: a crank gear fixed to a shaft that is connected to the crank assembly; and a spring gear engaged with the crank gear and fixed to the wind shaft.
19. The windup swing assembly of configuration 1, further comprising a wind mechanism comprising a wind shaft positioned along the drive spring axis (X3), the wind mechanism having a first end connected to a crank assembly and a second end connected to a spool.
20. The windup swing assembly of configuration 19, wherein the drive spring includes a first end connected to an attachment plate arranged around the wind shaft and a second end connected to the spool, such that rotation of the wind shaft winds the drive spring via the spool.
21. The windup swing assembly of configuration 20, wherein the wind mechanism further comprises: a first winding gear arranged around the wind shaft and attached to the attachment plate; and a second winding gear mating engaged with the first winding gear; wherein a release of stored energy from the drive spring rotationally drives the first winding gear which rotationally drives the second winding gear.
22. The windup swing assembly of configuration 21, further comprising an escapement assembly connected to the frame assembly, the escapement assembly comprising an escapement shaft connected to the second winding gear to rotationally drive the escapement shaft, the escapement shaft being oriented along an escapement axis (X2).
23. The windup swing assembly of configuration 22, wherein the escapement axis is oriented substantially parallel to the horizontal plane.
24. The windup swing assembly of configuration 22, wherein the escapement assembly further comprises an escapement gear fixed to the escapement shaft and configured to be driven via the second winding gear.
25. The windup swing assembly of configuration 24, wherein the escapement assembly further comprises: a carriage coupled to the escapement shaft and configured to rotate about the escapement axis (X2); and a pusher comprising a first end connected to the carriage and a second end connected to the swing arm assembly, wherein the pusher drives the swing arm assembly to rotate when the escapement gear is driven by the release of stored energy from the drive spring via the connection of the escapement shaft to the second winding gear.
26. The windup swing assembly of configuration 25, wherein: the pusher comprises a wire, the first end and second end of the pusher include angled portions relative to a main body of the pusher, the first end of the pusher is configured to be retained in an opening of the carriage including a through hole with at least one tapered region adjacent to the through hole, and the second end of the pusher is configured to be retained within an opening in a pivot housing of the swing arm assembly including a through hole and at least one tapered region adjacent to the through hole.
27. The windup swing assembly of configuration 25, wherein the pusher comprises a first bevel gear and a second bevel gear drivingly engaged with the first bevel gear, the first bevel gear is attached to the swing arm pivot, and the second bevel gear is connected to the carriage.
28. The windup swing assembly of configuration 25, wherein the escapement gear comprises a plurality of teeth and the escapement assembly further comprises: a pawl pivotally attached to the frame assembly, the pawl including a pawl tooth selectively engagable with a tooth of the escapement gear to prevent the escapement gear from rotating in a drive direction when the swing arm is a neutral state; and a dog pivotally attached to the carriage and selectively engagable with a tooth of the escapement gear when the swing arm is rotated and the pawl tooth is disengaged from the escapement gear.
29. The windup swing assembly of configuration 28, wherein the escapement assembly further comprises an actuator coupled to the escapement shaft and configured to rotate about the escapement axis (X2), the actuator selectively engages the pawl and the dog to control the selective engagement between the pawl and the dog with the escapement gear.
30. The windup swing assembly of configuration 28, further comprising an amplitude control assembly comprising a drop plate configured to selectively limit a stroke of the dog, and an amplitude control lever configured to selectively adjust a position of the drop plate.
31. The windup swing assembly of configuration 30, wherein the drop plate includes an engagement portion configured to engage with a portion of the dog and an appendage configured to engage with a portion of the amplitude control lever.
32. The windup swing assembly of configuration 31, wherein the amplitude control lever includes a first stop and a second stop that are spaced apart from each other and are each configured to engage with the appendage of the drop plate to control a swing amplitude.
33. The windup swing assembly of configuration 19, further comprising a torque limiting clutch configured to prevent overwinding of the drive spring.
34. The windup swing assembly of configuration 33, wherein the torque limiting clutch comprises a torque clutch spring assembled on the spool and configured to wind when the wind shaft is rotated in a winding direction and to slip when the drive spring is wound over a predetermined torque.
35. The windup swing assembly of configuration 33, wherein the torque limiting clutch comprises: a first housing operatively connected to the crank assembly, the first housing including clutch driver toothing; a clutch hub fixed to the crank assembly; and a clutch pawl pivotally connected to the clutch hub via a biasing element, the clutch pawl biased by the biasing element to selectively engage the clutch driver toothing; wherein when the drive spring is wound via the crank assembly, the clutch pawl engages the clutch driver toothing up to a predetermined torque limit to transmit torque from the crank assembly to the drive spring, and when torque transmitted by the crank assembly to the drive spring exceeds the predetermined torque limit, the clutch pawl disengages the clutch driver toothing to prevent further transmission of torque from the crank assembly to the drive spring.
36. The windup swing assembly of configuration 33, wherein the torque limiting clutch comprises: an input shaft connected to the crank assembly; an output shaft connected to the drive spring; a cap fixed to the input shaft; and a spool fixed to the output shaft and clamped to the cap; wherein the cap and spool are configured to slip relative to one another when a predetermined force is overcome to prevent the drive spring from being overwound.
37. The windup swing assembly of configuration 33, wherein the torque limiting clutch comprises: a shaft connected to the crank assembly; an input hub comprising at least one catch; and an output hub connected to the shaft, the output hub comprising at least one protrusion engageable with the catch; wherein the at least one protrusion is configured to disengage from the at least one catch when a predetermined force from the crank assembly is overcome to prevent the drive spring from being overwound.
38. The windup swing assembly of configuration 37, wherein the at least one catch is a resilient member biased toward engagement with the at least one protrusion.
39. The windup swing assembly of configuration 37, wherein the at least one catch is pivotally attached to the input hub.
40. The windup swing assembly of configuration 37, further comprising a spring connected to the at least one catch and biasing the at least one catch toward engagement with the at least one protrusion.
41. The windup swing assembly of configuration 1 wherein the swing arm is connected to the swing arm pivot via a swing arm connector comprising a rivet and a snap pin.
42. The windup swing assembly of configuration 1, wherein the swing arm assembly comprises a seat frame, and a center of gravity (COG) of an occupant within the seat frame is approximately intersected by an axis of recline (AR) for the seat frame and an axis of seat rotation (ASR).
43. The windup swing assembly of configuration 1, wherein the swing arm assembly comprises a seat frame, and an axis of recline (AR) of a seat frame and an axis of seat rotation (ASR) of the seat frame intersect with each other, and both axes extend through a center of gravity (COG) defined by the seat frame and an occupant of the windup swing assembly.
44. A swing assembly comprising: a frame assembly; and a swing arm assembly connected to the frame assembly, the swing arm assembly including swing arm pivot pivotally attached to the frame assembly, a swing arm having a first end connected to the swing arm pivot and a second end connected to a seat assembly; wherein the swing arm is rotatable about a swing arm axis (X1) that is oriented in a non-horizontal direction relative to a horizontal plane.
45. The swing assembly of configuration 44, wherein the swing arm is L-shaped.
46. The swing assembly of configuration 44, wherein the swing arm further comprises a support hub positioned at the second end of the swing arm and configured to receive a seat assembly.
47. The swing assembly of configuration 46, wherein the seat assembly is detachably connected to the support hub.
48. The swing assembly of configuration 46, wherein the support hub is rotatable relative to the swing arm.
49. The swing assembly of configuration 46, wherein the seat assembly includes a connection recess and the support hub includes a connection stud received within the connection recess to secure the seat assembly to the support hub.
50. The swing assembly of configuration 46, wherein the support hub comprises: a stationary hub fixed to the swing arm; and a rotation hub rotatably connected to the stationary hub, the rotation hub is configured to attach to the seat assembly and rotate relative to the stationary hub.
51. The swing assembly of configuration 50, further comprising: a plunger; a biasing element attaching the plunger to the stationary hub; and a detent formed on the rotation hub to selective receive the plunger to inhibit rotation between the rotation hub and the stationary hub.
52. The swing assembly of configuration 50, wherein the seat assembly further comprises: a seat frame; at least one support leg connected to the seat frame; and a connection assembly including a connection recess to receive the rotation hub.
53. The swing assembly of configuration 51, wherein the rotation hub includes at least one rib, and the connection recess defines at least one channel to receive the at least one rib.
54. The swing assembly of configuration 51, wherein the seat assembly includes an actuator to release an engagement between the seat assembly and the support hub.
55. The swing assembly of configuration 54, wherein the connection assembly comprises: a main body; a pivot member having a first end and a second end and pivotally connected to the main body at a pivot connection positioned between the first end and the second end, the first end of the pivot member attached to the actuator; an actuator biasing element exerting a biasing force on the first end of the pivot member to bias the actuator to a resting position; and a hub latch connected to the second end of the pivot member and biased into a locked position with the rotation hub to secure the seat assembly to the rotation hub; wherein movement of the actuator to an actuated position overcomes the biasing force of the actuator biasing element and causes the pivot member to pivot about the pivot connection, which causes the hub latch to move to an unlocked position and disengage from the rotation hub.
56. The swing assembly of configuration 52, wherein the seat assembly further comprises a support base for use of the seat assembly independent from the swing arm assembly when the seat assembly is detached from the swing arm assembly.
57. A windup swing assembly comprising: a frame assembly; a drive spring positioned within the frame assembly and oriented in a non-vertical direction relative to a vertical plane; a crank assembly provided on a frame assembly, the crank assembly being configured to input a driving torque to the drive spring; a seat frame rotatably connected to the frame assembly, the seat frame including a swing arm oriented in a non-horizontal direction relative to a horizontal plane; and a gear assembly connected to the crank assembly and the drive spring to transfer energy from the drive spring to provide a swinging motion to the seat frame.
58. A method of using a windup swing assembly, the method comprising: engaging a crank assembly by rotating a crank handle, wherein the crank assembly is connected to a wind mechanism; winding a drive spring connected to the wind mechanism; and selectively releasing energy from the drive spring via an escapement assembly having a carriage that is linked to a swing arm pivot via a pusher, such that the swing arm pivot moves in a first direction during a power stroke, and the swing arm pivot moves in a second direction during a non-power stroke.
59. A method of driving a seat frame of a windup swing assembly, the method comprising: rotating a crank assembly connected to a drive spring such that the drive spring is wound, the drive spring positioned along a drive spring axis (X3) oriented in a non-vertical direction relative to a vertical plane; transferring energy from the wound drive spring to an escapement assembly, the escapement assembly having an escapement axis (X2) that is angled relative to the drive spring axis (X3); and selectively releasing energy from the escapement assembly to a swing arm pivot, wherein the swing arm pivot is connected to the seat frame and has a swing arm axis (X1), the swing arm axis (X1) oriented in a non-horizontal direction relative to a horizontal plane and being angled relative to the drive spring axis (X3) and the escapement axis (X2).

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

***

1. A windup swing assembly comprising:
a frame assembly comprising a housing;
a drive spring positioned within the housing and having a drive spring axis (X3) oriented in a non-vertical direction relative to a vertical plane; and
a swing arm assembly connected to the frame assembly to receive energy from the drive spring, the swing arm assembly including a swing arm and a swing arm pivot, the swing arm is rotatable about a swing arm axis (X1) that is oriented in a non-horizontal direction relative to a horizontal plane.

2. The windup swing assembly of claim 1, wherein the drive spring axis (X3) is angled relative to the swing arm axis (X1).)

3. The windup swing assembly of claim 1, wherein the swing arm axis (X1) is oriented at an angle of 30-70 degrees relative to the horizontal plane.

4. The windup swing assembly of claim 1, wherein the drive spring axis (X3) is oriented at an angle of 5-20 degrees relative to the vertical plane.

5. The windup swing assembly of claim 1, further comprising an escapement assembly connected to the frame assembly having an escapement axis (X2) that is angled relative to the swing arm axis (X1).

6. The windup swing assembly of claim 5, wherein the swing arm axis (X1), the escapement axis (X2), and the drive spring axis (X3) are each angled relative to one another.

7. The windup swing assembly of claim 5, wherein the escapement axis (X2) is substantially parallel to the horizontal plane.

8. The windup swing assembly of claim 1, wherein the swing arm assembly includes an adjustment assembly and a seat frame, and the adjustment assembly is configured to adjust a recline angle of the seat frame.

9. The windup swing assembly of claim 8, wherein the drive spring is arranged laterally relative to the seat frame.

10. The windup swing assembly of claim 1, wherein the frame assembly comprises:
an upper end and a lower end;
a base is positioned at a lower end of the frame assembly;
and an upright frame member extending from the base to the upper end of the frame assembly.

11. The windup swing assembly of claim 10, wherein the frame assembly further comprises:
a support positioned at the lower end of the frame assembly, the support configured to rest on a ground surface, and
a handle positioned adjacent the upper end of the frame assembly.

12. The windup swing assembly of claim 11, wherein the support extends in an opposite direction from the base.

13. The windup swing assembly of claim 1, wherein a crank assembly is provided on the frame assembly to wind the drive spring.

14. The windup swing assembly of claim 13, wherein the crank assembly comprises a crank handle that is configured to extend away from the frame assembly, and rotation of the crank handle about a crank pivot winds the drive spring.

15. The windup swing assembly of claim 14, wherein the crank handle is configured to fold outward from the frame assembly in a use condition and is configured to fold into a pocket defined on the frame assembly in a storage condition.

16. The windup swing assembly of claim 13, further comprising a wind mechanism arranged between the crank assembly and the drive spring to translate cranking input from the crank assembly to wind the drive spring.

17. The windup swing assembly of claim 16, wherein:
the wind mechanism comprises a wind shaft connected to the crank assembly at a first end and connected to a spool at a second end; and
the drive spring includes a first end connected to an attachment plate arranged around the wind shaft and a second end connected to the spool, such that rotation of the wind shaft winds the drive spring via the spool.

18. The windup swing assembly of claim 17, further comprising a gear assembly arranged between the crank assembly and the drive spring to reduce a force required to wind the drive spring, the gear assembly comprising:
a crank gear fixed to a shaft that is connected to the crank assembly; and
a spring gear engaged with the crank gear and fixed to the wind shaft.

19. The windup swing assembly of claim 1, further comprising a wind mechanism comprising a wind shaft positioned along the drive spring axis (X3), the wind mechanism having a first end connected to a crank assembly and a second end connected to a spool.

20. The windup swing assembly of claim 19, wherein the drive spring includes a first end connected to an attachment plate arranged around the wind shaft and a second end connected to the spool, such that rotation of the wind shaft winds the drive spring via the spool.

21. The windup swing assembly of claim 20, wherein the wind mechanism further comprises:
a first winding gear arranged around the wind shaft and attached to the attachment plate; and
a second winding gear mating engaged with the first winding gear;
wherein a release of stored energy from the drive spring rotationally drives the first winding gear which rotationally drives the second winding gear.

22. The windup swing assembly of claim 21, further comprising an escapement assembly connected to the frame assembly, the escapement assembly comprising an escapement shaft connected to the second winding gear to rotationally drive the escapement shaft, the escapement shaft being oriented along an escapement axis (X2).

23. The windup swing assembly of claim 22, wherein the escapement axis is oriented substantially parallel to the horizontal plane.

24. The windup swing assembly of claim 22, wherein the escapement assembly further comprises an escapement gear fixed to the escapement shaft and configured to be driven via the second winding gear.

25. The windup swing assembly of claim 24, wherein the escapement assembly further comprises:
a carriage coupled to the escapement shaft and configured to rotate about the escapement axis (X2); and
a pusher comprising a first end connected to the carriage and a second end connected to the swing arm assembly,
wherein the pusher drives the swing arm assembly to rotate when the escapement gear is driven by the release of stored energy from the drive spring via the connection of the escapement shaft to the second winding gear.

26. The windup swing assembly of claim 25, wherein:
the pusher comprises a wire,
the first end and second end of the pusher include angled portions relative to a main body of the pusher,
the first end of the pusher is configured to be retained in an opening of the carriage including a through hole with at least one tapered region adjacent to the through hole, and
the second end of the pusher is configured to be retained within an opening in a pivot housing of the swing arm assembly including a through hole and at least one tapered region adjacent to the through hole.

27. The windup swing assembly of claim 25, wherein the pusher comprises a first bevel gear and a second bevel gear drivingly engaged with the first bevel gear, the first bevel gear is attached to the swing arm pivot, and the second bevel gear is connected to the carriage.

28. The windup swing assembly of claim 25, wherein the escapement gear comprises a plurality of teeth and the escapement assembly further comprises:
a pawl pivotally attached to the frame assembly, the pawl including a pawl tooth selectively engagable with a tooth of the escapement gear to prevent the escapement gear from rotating in a drive direction when the swing arm is a neutral state; and
a dog pivotally attached to the carriage and selectively engagable with a tooth of the escapement gear when the swing arm is rotated and the pawl tooth is disengaged from the escapement gear.

29. The windup swing assembly of claim 28, wherein the escapement assembly further comprises an actuator coupled to the escapement shaft and configured to rotate about the escapement axis (X2), the actuator selectively engages the pawl and the dog to control the selective engagement between the pawl and the dog with the escapement gear.

30. The windup swing assembly of claim 28, further comprising an amplitude control assembly comprising a drop plate configured to selectively limit a stroke of the dog, and an amplitude control lever configured to selectively adjust a position of the drop plate.

31. The windup swing assembly of claim 30, wherein the drop plate includes an engagement portion configured to engage with a portion of the dog and an appendage configured to engage with a portion of the amplitude control lever.

32. The windup swing assembly of claim 31, wherein the amplitude control lever includes a first stop and a second stop that are spaced apart from each other and are each configured to engage with the appendage of the drop plate to control a swing amplitude.

33. The windup swing assembly of claim 19, further comprising a torque limiting clutch configured to prevent overwinding of the drive spring.

34. The windup swing assembly of claim 33, wherein the torque limiting clutch comprises a torque clutch spring assembled on the spool and configured to wind when the wind shaft is rotated in a winding direction and to slip when the drive spring is wound over a predetermined torque.

35. The windup swing assembly of claim 33, wherein the torque limiting clutch comprises:
a first housing operatively connected to the crank assembly, the first housing including clutch driver toothing;
a clutch hub fixed to the crank assembly; and
a clutch pawl pivotally connected to the clutch hub via a biasing element, the clutch pawl biased by the biasing element to selectively engage the clutch driver toothing;
wherein when the drive spring is wound via the crank assembly, the clutch pawl engages the clutch driver toothing up to a predetermined torque limit to transmit torque from the crank assembly to the drive spring, and
when torque transmitted by the crank assembly to the drive spring exceeds the predetermined torque limit, the clutch pawl disengages the clutch driver toothing to prevent further transmission of torque from the crank assembly to the drive spring.

36. The windup swing assembly of claim 33, wherein the torque limiting clutch comprises:
an input shaft connected to the crank assembly;
an output shaft connected to the drive spring;
a cap fixed to the input shaft; and
a clutch spool fixed to the output shaft and clamped to the cap;
wherein the cap and spool are configured to slip relative to one another when a predetermined force is overcome to prevent the drive spring from being overwound.

37. The windup swing assembly of claim 33, wherein the torque limiting clutch comprises:
a shaft connected to the crank assembly;
an input hub comprising at least one catch; and
an output hub connected to the shaft, the output hub comprising at least one protrusion engageable with the catch;
wherein the at least one protrusion is configured to disengage from the at least one catch when a predetermined force from the crank assembly is overcome to prevent the drive spring from being overwound.

38. The windup swing assembly of claim 37, wherein the at least one catch is a resilient member biased toward engagement with the at least one protrusion.

39. The windup swing assembly of claim 37, wherein the at least one catch is pivotally attached to the input hub.

40. The windup swing assembly of claim 37, further comprising a spring connected to the at least one catch and biasing the at least one catch toward engagement with the at least one protrusion.

41. The windup swing assembly of claim 1 wherein the swing arm is connected to the swing arm pivot via a swing arm connector comprising a rivet and a snap pin.

42. The windup swing assembly of claim 1, wherein the swing arm assembly comprises a seat frame, and a center of gravity (COG) of an occupant within the seat frame is intersected by an axis of recline (AR) for the seat frame and an axis of seat rotation (ASR).

43. The windup swing assembly of claim 1, wherein the swing arm assembly comprises a seat frame, and an axis of recline (AR) of a seat frame and an axis of seat rotation (ASR) of the seat frame intersect with each other, and both axes extend through a center of gravity (COG) defined by the seat frame and an occupant of the windup swing assembly.

44. A swing assembly comprising:
a frame assembly; and
a swing arm assembly connected to the frame assembly, the swing arm assembly including swing arm pivot pivotally attached to the frame assembly, a swing arm having a first end connected to the swing arm pivot and a second end connected to a seat assembly;
wherein the swing arm is rotatable about a swing arm axis (X1) that is oriented in a non-horizontal direction relative to a horizontal plane.

45. The swing assembly of claim 44, wherein the swing arm is L-shaped.

46. The swing assembly of claim 44, wherein the swing arm further comprises a support hub positioned at the second end of the swing arm and configured to receive a seat assembly.

47. The swing assembly of claim 46, wherein the seat assembly is detachably connected to the support hub.

48. The swing assembly of claim 46, wherein the support hub is rotatable relative to the swing arm.

49. The swing assembly of claim 46, wherein the seat assembly includes a connection recess and the support hub includes a connection stud received within the connection recess to secure the seat assembly to the support hub.

50. The swing assembly of claim 46, wherein the support hub comprises:
a stationary hub fixed to the swing arm; and
a rotation hub rotatably connected to the stationary hub, the rotation hub is configured to attach to the seat assembly and rotate relative to the stationary hub.

51. The swing assembly of claim 50, further comprising:
a plunger;
a biasing element attaching the plunger to the stationary hub; and
a detent formed on the rotation hub to selective receive the plunger to inhibit rotation between the rotation hub and the stationary hub.

52. The swing assembly of claim 50, wherein the seat assembly further comprises:
a seat frame;
at least one support leg connected to the seat frame; and
a connection assembly including a connection recess to receive the rotation hub.

53. The swing assembly of claim 52, wherein the rotation hub includes at least one rib, and the connection recess defines at least one channel to receive the at least one rib.

54. The swing assembly of claim 52, wherein the seat assembly includes an actuator to release an engagement between the seat assembly and the support hub.

55. The swing assembly of claim 54, wherein the connection assembly comprises:
a main body;
a pivot member having a first end and a second end and pivotally connected to the main body at a pivot connection positioned between the first end and the second end, the first end of the pivot member attached to the actuator;
an actuator biasing element exerting a biasing force on the first end of the pivot member to bias the actuator to a resting position; and
a hub latch connected to the second end of the pivot member and biased into a locked position with the rotation hub to secure the seat assembly to the rotation hub;
wherein movement of the actuator to an actuated position overcomes the biasing force of the actuator biasing element and causes the pivot member to pivot about the pivot connection, which causes the hub latch to move to an unlocked position and disengage from the rotation hub.

56. The swing assembly of claim 52, wherein the seat assembly further comprises a support base for use of the seat assembly independent from the swing arm assembly when the seat assembly is detached from the swing arm assembly.

57. A windup swing assembly comprising:
a frame assembly;
a drive spring positioned within the frame assembly and oriented in a non-vertical direction relative to a vertical plane;
a crank assembly provided on a frame assembly, the crank assembly being configured to input a driving torque to the drive spring;
a seat frame rotatably connected to the frame assembly, the seat frame including a swing arm oriented in a non-horizontal direction relative to a horizontal plane; and
a gear assembly connected to the crank assembly and the drive spring to transfer energy from the drive spring to provide a swinging motion to the seat frame.

58. A method of using a windup swing assembly, the method comprising:
engaging a crank assembly by rotating a crank handle, wherein the crank assembly is connected to a wind mechanism;
winding a drive spring connected to the wind mechanism; and
selectively releasing energy from the drive spring via an escapement assembly having a carriage that is linked to a swing arm pivot via a pusher, such that the swing arm pivot moves in a first direction during a power stroke, and the swing arm pivot moves in a second direction during a non-power stroke.

59. (canceled)
